(19) United States
(12) Patent Application Publication
(10) Pub. No.: US 2026/0222819 A1
(43) Pub. Date: Jul. 30, 2026

(54) SYSTEM AND METHOD FOR FORMING AN AD-HOC SECURE SUPERCOMPUTING CLUSTER TO PERFORM PARALLEL PROCESSING OF DEEP NEURAL NETWORK LAYERS ACROSS A PLURALITY OF INFORMATION HANDLING SYSTEMS IN TRUE PRESENCE OF ONE ANOTHER

(71) Applicant: Dell Products LP, Round Rock, TX (US)

(72) Inventors: Rachid M. Alameh, Crystal Lake, IL (US); Jarrett Simerson, Northbrook, IL (US); Daniel L. Hamlin, Round Rock, TX (US); Rocco Ancona, Chapel Hill, NC (US)

(73) Assignee: Dell Products LP, Round Rock, TX (US)

(21) Appl. No.: 19/039,675

(22) Filed: Jan. 28, 2025

(51) Int. Cl. H04W 12/55; H04W 12/00; H04W 12/63

(52) U.S. Cl. CPC H04W 12/55; H04W 12/009; H04W 12/63

(57) ABSTRACT

A first information handling system executing machine readable code instructions of an ad-hoc secured supercomputer orchestration system may comprise a wireless interface adapter to receive from other information handling systems, capacitive sensor measurements indicating that all of the information handling systems are within a threshold distance of each other, a configuration sensor to sense that the first information handling system is open or on top of the other information handling systems, a hardware processor to execute machine readable code instructions to assign the first information handling system as a cluster controlling anchor information handling system, and the wireless interface adapter to distribute and transmit, via secured sideband communication, deep neural network layers for parallel processing at the other information handling systems to balance power, processing, and thermal capacities across the other information handling systems and to receive and aggregate outputs of such parallel processing.

### FIELD OF THE DISCLOSURE

The present disclosure generally relates to distributing processing of computing tasks across a plurality of information handling systems. The present disclosure more specifically relates to forming an ad-hoc secure supercomputing cluster to perform parallel processing of deep neural network (DNN) layers across a plurality of information handling systems that may include neural processing unit (NPU) artificial intelligence (AI) edge computing boxes determined to be within line-of-sight or true presence of one another and potentially a user.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating a plurality of information handling systems for forming an ad-hoc secure supercomputing cluster to perform parallel processing of deep neural network (DNN) layers across the plurality of information handling systems determined to be in true presence of one another in their current positional configuration according to an embodiment of the present disclosure;

FIG. 2 is a block diagram an information handling system for forming an ad-hoc secure supercomputing cluster across a plurality of neural processing unit (NPU) artificial intelligence (AI) edge computing boxes determined to be in true presence of one another and the information handling system according to an embodiment of the present disclosure;

FIG. 3 is a graphical diagram illustrating a plurality of information handling systems in a stacked configuration to establish true presence with one another using one or more true presence sensor systems according to an embodiment of the present disclosure;

FIG. 4 is a graphical diagram illustrating an information handling system establishing true presence with a stacked configuration of neural processing unit (NPU) artificial intelligence (AI) edge computing boxes using one or more true presence sensor systems according to an embodiment of the present disclosure;

FIG. 5 is a graphical diagram illustrating a plurality of information handling systems in a disbursed configuration, located within the same room and within line-of sight of a detected user to establish true presence with one another established with true presence sensor systems according to an embodiment of the present disclosure;

FIG. 6 is a flow diagram illustrating a method of determining that a plurality of information handling systems are capable of being in line-of-sight of each other or an individual user in their current positional configuration with true presence sensing according to an embodiment of the present disclosure; and

FIG. 7 is a flow diagram illustrating a method of forming an ad-hoc secure supercomputing cluster to perform parallel processing across a plurality of information handling systems according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

As popularity of artificial intelligence (AI) rises, corresponding need to access unused processing capacity for processing of deep neural network (DNN) layers in AI methodologies also rises. One way manufacturers have addressed this issue is by production of neural processing units (NPUs) which are hardware processors designed with high processing capacity specifically for AI applications and used in information handling systems. Another way in which manufacturer have addressed this issue is by production of NPU AI edge computing boxes that house such NPUs and may be securely coupled with information handling systems to orchestrate usage of such NPUs for processing of deep neural network (DNN) layers in AI methodologies. The ad-hoc secured supercomputer orchestration system in embodiments of the present disclosure address this issue by automatically forming an ad-hoc secured supercomputer cluster of information handling systems that may include NPU AI edge computing boxes or currently unused computer information handling systems that are viewable in line-of-sight of an individual user at an anchor information handling system to enhance security and to increase the available capacity for processing DNN layers across a larger plurality of information handling systems and hardware processors.

The hardware processors across such a plurality of information handling systems in embodiments here may perform a method of determining that the plurality of information handling systems are in true presence of one another, or are capable of being in line-of-sight of an individual user in their current positional configuration with respect to one another, using one or more true presence sensing systems, including ultrawide band, capacitive contact or proximity sensing between the plurality of information handling systems or NPU AI edge computing boxes. In some embodiments, this capacitive proximity sensing may be further secured by generating and using encoded electrical fields (e-field) capacitively transmitted and detected between encoded electrical field (e-field). This may heighten security of the supercomputing cluster formed through wireless communication among these information handling systems by inhibiting physical tampering with these devices by an unauthorized user. Presence of each of these information handling systems within safe proximity of one another in embodiments herein may be determined using various techniques. For example, capacitive sensors at one or more of the plurality of information handling systems may work in tandem with hardware processors and capacitive sensing driver controller integrated circuits at those information handling systems executing machine readable code instructions of an ad-hoc secured supercomputer orchestration system to determine whether the information handling systems are stacked nearby or in physical contact with one another with capacitive contact or proximity detection in one embodiment.

In some embodiments, physical proximity or stacking is detected of one or more of the information handling systems in proximity to one another before automatic formation of an ad-hoc secured supercomputer amongst those information handling systems by an ad-hoc secured supercomputer orchestration system executing at one information handling system determined to be a cluster controlling anchor information handling systems. In one embodiment, plural information handling systems may be stacked on one another and have surface mounted capacitive sensors, such as on a top lid chassis or bottom base chassis of a laptop information handling system, to detect stacking of an information handling system in the stack via capacitive contact. These chassis mounted capacitive sensors operate as a true presence sensing system in embodiments herein to ensure each device is within true presence of one another before automatic formation of the ad-hoc secured supercomputer in embodiments herein. This may heighten security of the ad-hoc supercomputing cluster automatically formed through wireless communication among these information handling systems by inhibiting physical tampering with these devices by an unauthorized user due to close proximity with one another. The capacitive sensors may determine which information handling system in a stacked arrangement is a top-located information handling system based on the capacitive sensors detecting no additional information handling systems above the top-of-stack information handling system. The ad-hoc secured supercomputer orchestration system at that top-of-stack information handling system may determine it should operate as the cluster controlling anchor information handling system in embodiments herein. In further embodiments, a lid sensor may detect a laptop top lid chassis is open to determine or confirm the cluster controlling anchor information handling system of a top of stack information handling system.

In a second embodiment of the present disclosure, the capacitive sensors at one or more of the plurality of information handling systems, that includes NPU AI edge computing boxes and at least one information handling system with IO capabilities, may work in tandem with hardware processors and capacitive sensing driver controller integrated circuits at those information handling systems executing machine readable code instructions of an ad-hoc secured supercomputer orchestration system to determine whether the NPU AI edge computing boxes are stacked using capacitive proximity detection having limited range and the at least one information handling system is in physical proximity based on capacitive or other proximity detection. In this embodiment, one or more of the information handling systems may be NPU AI edge computing boxes stacked such that additional thermal ventilation is made available through the stack. A cluster controlling anchor information handling system with IO capabilities may be placed on top of the stack or on the side proximate to the other information handling system and within capacitive sensing range or even detected based on another true presence sensing modality. In a further embodiment, the capacitive proximity sensing may be further secured by generating and using encoded electrical fields (e-field) capacitively transmitted by a capacitive chassis of at least one of the NPU AI edge computing boxes within a stacked or slotted configuration or the at least one information handling system. The encoded electrical field (e-field) detected by all NPU AI edge computing boxes and the at least one information handling system either stacked or within a capacitive proximity range by capacitive sensors or a capacitive chassis. Again, the above embodiment may heighten security of the ad-hoc supercomputing cluster automatically formed through wireless communication among these information handling systems by inhibiting physical tampering with these devices by an unauthorized user due to proximity with one another. The capacitive sensors on each of the information handling systems may determine the at least one information handling system with IO capabilities in a stacked arrangement or within detected proximity is the cluster controlling anchor information handling system by the ad-hoc secured supercomputer orchestration system in embodiments herein.

Additional true presence sensor detection modalities may confirm such physical proximity or stacking of the above two embodiments via other types of sensors. For example, inertial measurement units at the plurality of information handling systems may be used at least two of the information handling systems to detect simultaneous jarring or bumping of those devices that may occur as those information handling systems are placed in physical contact with one another. As another example, each of the information handling systems may perform a wireless handshake using short-range communications with one another to establish that each of the information handling systems is within short-range communication and thus confirms their current positional configuration. In yet another example, each of the information handling systems may determine that the plurality of information handling systems simultaneously detect the same emitted audio signal to confirm that there are no physical obstructions such as walls or windows between the information handling systems. In embodiments in which a plurality of the information handling systems slotted or arranged to form the supercomputing cluster and include one or more NPU AI edge computing boxes, those devices may determine that capacitors, such as a driven capacitive chassis by capacitive sensor driver integrated circuits at each NPU AI edge computing box or an anchor information handling system, are detecting the same emitted encoded electrical field (e-field) as one another. Each of these methods may establish physical proximity of the plurality of information handling systems, including NPU AI edge computing boxes, with one another in an embodiments. Further, in some embodiments the plurality of information handling systems, including NPU AI edge computing boxes are in a stacked formation either directly atop one another or with minimal spacing between the information handling systems to allow for heat dissipation.

In a third embodiment described herein, an ad-hoc secured supercomputer cluster may be formed using a plurality of information handling systems in dispersed locations within the same room and within line-of-sight of a user whose presence has been detected by at least one of the information handling systems. In such a case, hardware processors at the information handling systems may execute machine readable code instructions of the ad-hoc secured supercomputer orchestration system in tandem with global positioning satellite (GPS) sensors to determine that the information handling systems have matching GPS locations or GPS locations sufficiently close to one another plus another true sensing system modality such as audio detection of a user’s voice or audible sound captured simultaneously across the plurality of information handling systems, video capture of a user within line of sight or one or more of the plurality of information handling systems, or human presence or motion detection synching by one or more of the plurality of information handling systems to indicate that they are in the same room.

For example, upon detection of the user speaking a clustering trigger phrase aloud, such as “form a cluster,” or receiving another trigger detected at one or more information handling systems, the user’s position may be sensed with respect to the plurality of information handling systems, including NPU AI edge computing boxes. The plurality of information handling systems may sense the user’s position using true presence sensors including beam-forming with microphones and speakers, ultra-wideband (UWB) radio frequency transmissions, or wireless signal strength indicators for WLAN or Bluetooth ® communications. Further, the plurality of information handling systems, including NPU AI edge computing boxes, may sense relative proximity to the user within the room using these and other methods as described in embodiments herein such as via microphone beamforming, ultra wideband range sensing, infrared time of flight range sensing, camera range sensor sensing, or others operating as the true presence sensing system to confirm user line-of-sight with the plurality of information handling systems that may be used as an ad-hoc supercomputing. By identifying the user’s location using such methods, each information handling system may establish that the user is in line-of-sight of each information handling system that may form an ad-hoc secure supercomputing cluster distributed across a room before such an ad-hoc secure supercomputing cluster is automatically formed. In such an embodiment, the various modalities of the true sensor system modalities, for example UWB sensing, may determine which or the plurality of information handling systems is at a closest distance to the user to determine it should operate as the cluster controlling anchor information handling system in embodiments herein. In further embodiments, a lid sensor may detect a laptop top lid chassis is open to determine or confirm that a proximate information handling system proximate to a user is the cluster controlling anchor information handling system.

Once true presence between the information handling systems or between the information handling systems and the identified user has been confirmed using the above methodologies of the three embodiments described, each of the information handling systems may form an ad-hoc secure supercomputing cluster to perform parallel processing of DNN layers. A hardware processor at one of the information handling systems determined to be in true presence of the other information handling systems, including one or more NPU AI edge computing boxes, may execute computer readable code instructions of the ad-hoc secured supercomputer orchestration system to sense it is located above the other information handling systems in a stacked configuration, it has an open lid, has IO capabilities, or it is nearest to a user and transmit an identity as the cluster controlling anchor information handling system the other information handling systems and NPU AI edge computing boxes in true presence in various embodiments. This may identify the information handling system most likely to be accessible to the user as the controlling anchor information handling system.

The wireless interface adapter at the cluster controlling anchor information handling system may work in tandem with all other information handling systems, including NPU AI edge computing boxes, in true presence of the cluster controlling anchor information handling system to establish secure wireless sideband communication wireless links with the cluster controlling anchor information handling system that are distinct from any previously shared wireless network. This may ensure that the communications and commands transmitted from the cluster controlling anchor information handling system to the remaining information handling systems are secure and cannot be hacked by an individual outside of the room containing all of the information handling systems. All of the information handling systems in true presence of the cluster controlling anchor information handling system may share system capabilities, including processing capacity, audio capabilities, and thermal boundaries with the cluster controlling anchor information handling system via the secure wireless sideband communication wireless links in embodiments herein. As described herein, some information handling systems in true presence of the cluster controlling anchor information handling system may comprise NPU AI edge computing boxes that lack separate operating systems and input/output devices. The cluster controlling anchor information handling system in embodiments may disable a display, non-audio IO devices, and operating system of the information handling systems in true presence of the cluster controlling anchor information handling system that are not NPU AI edge computing box, via the secure sideband communication wireless links. The hardware processor at the cluster controlling anchor information handling system may also execute code instructions of the ad-hoc secured supercomputer orchestration system to orchestrate input for a microphone and output for a speaker at the information handling system in true presence of the cluster controlling anchor information handling system that is not an NPU AI edge computing box, via the secure sideband communication wireless links, to minimize echo or interference across the entire cluster.

All information handling systems in true presence of the cluster controlling anchor information handling system, including NPU AI edge computing boxes may transmit system metrics to the cluster controlling anchor information handling system, including current processor usage, current thermal measurements, and current power measurements. The hardware processor at the cluster controlling anchor information handling system may execute machine readable code instructions of the ad-hoc secured supercomputer orchestration system to determine, based on these received metrics, a balanced distribution of DNN layers for processing at each of the information handling systems in true presence of the cluster controlling anchor information handling system to balance current power, processing, and thermal metrics across each of the information handling systems in true presence of the cluster controlling anchor information handling system. The wireless interface adapter at the cluster controlling anchor information handling system may transmit commands via the secure sideband communication wireless links to execute the balanced distribution of DNN layers for processing at each of the information handling systems in true presence of the cluster controlling anchor information handling system. Following such a processing, the hardware processor at the cluster controlling anchor information handling system may execute machine readable code instructions of the ad-hoc secured supercomputer orchestration system to aggregate the received DNN layer outputs from the information handling systems in true presence of the cluster controlling anchor information handling system. In such a way, an ad-hoc secured supercomputer cluster of information handling systems may be formed that may include NPU AI edge computing boxes or currently unused computers that are viewable in line-of-sight of an individual user to enhance security and to increase the available capacity for processing DNN layers across a larger plurality of information handling systems and hardware processors.

The cluster controlling anchor information handling system may also work in tandem with the other information handling systems previously determined to be in true presence of the cluster controlling anchor information handling system to routinely confirm that each of these information handling systems are still in true presence of one another or determine if a false true presence sensor signal is received. If it is determined that any of the information handling systems are no longer in true presence of one another, a new group of information handling systems that are confirmed to still be or now be in true presence of one another may be identified. In such a way, new secure sideband communication wireless links may be established among the new group of information handling systems that excludes the information handling system determined to no longer be in true presence of the remainder of the information handling systems forming the previous ad-hoc secure cluster.

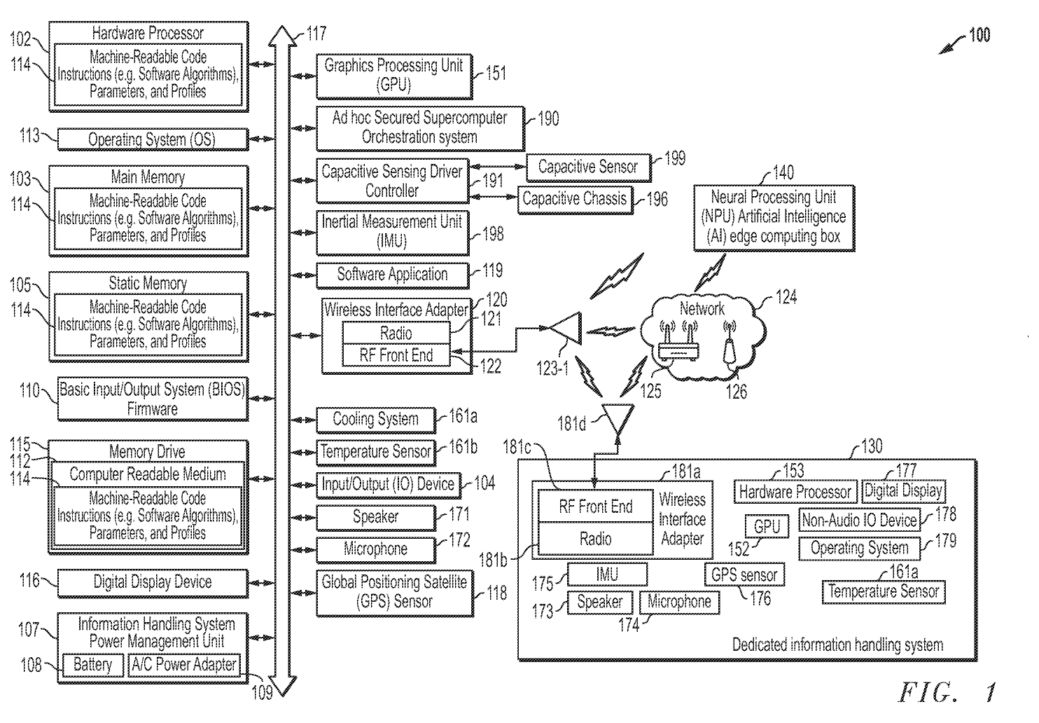

Turning now to the figures, FIG. 1 illustrates an information handling system 100 similar to the information handling systems according to several embodiments of the present disclosure. As described herein, a hardware processor 102 of an information handling system 100 may execute machine readable code instructions 114 of the ad-hoc secured supercomputer orchestration system 190 in an embodiment to automatically form an ad-hoc secured supercomputer cluster of information handling systems that may include NPU AI edge computing boxes 140 or currently unused computers 130 that are detected as stacked, within capacitive proximity of each other, or viewable in line-of-sight of a user. Such proximity determination of the plural embodiments herein may be detected by one or more true presence sensor systems to enhance security and to increase the available capacity for processing DNN layers across a larger plurality of information handling systems 100, 130, and 140 and hardware processors of those information handling systems 100, 130, and 140.

The hardware processors, including 102, 151, 152, and 153 across such a plurality of information handling systems 100, 130, and 140 in an embodiment may perform a method of determining that the plurality of information handling systems 100, 130, and 140 are in true presence of one another, or are capable of being in line-of-sight of an individual user in their current positional configuration as determined by the one or more true presence sensor systems of embodiments herein. This may heighten security of the supercomputing cluster automatically formed through wireless communication, via wireless interface adapter 120 among these information handling systems 100, 130 (e.g., via wireless interface adapter 181a), and 140 by inhibiting physical tampering with these devices 100, 130, and 140 by an unauthorized user due to the true presence sensor system proximity determination. Presence of each of these information handling systems 100, 130, and 140 within one another or line-of-sight of a user in embodiments herein may be determined using various techniques.

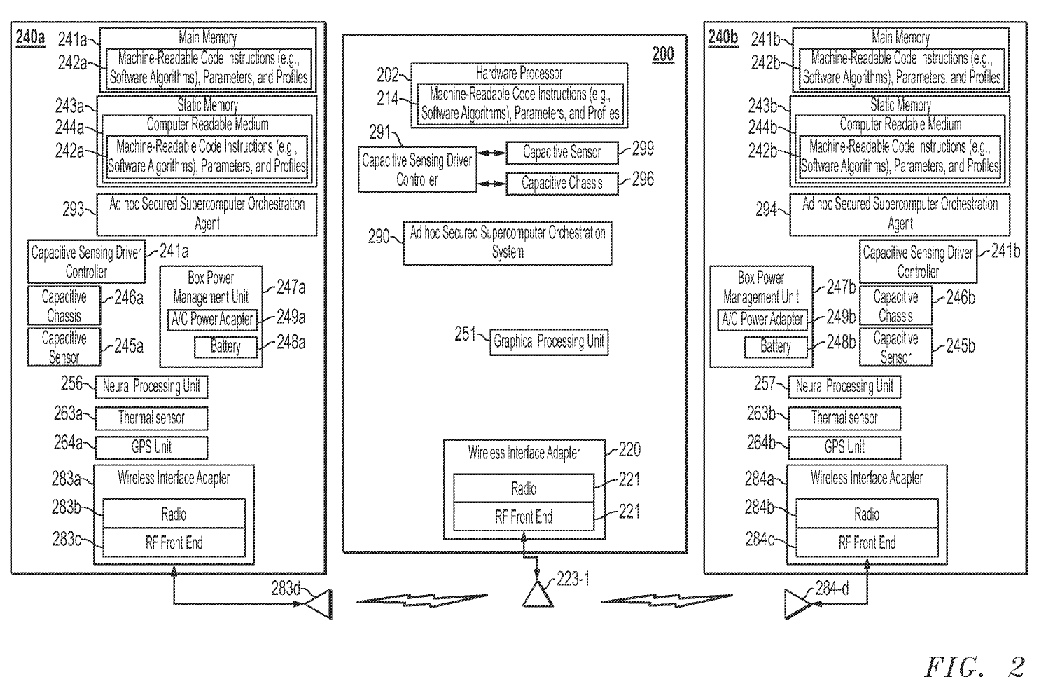

For example, a capacitive sensor 199 may work in tandem with the hardware processor 102 executing machine readable code instructions 114 of the ad-hoc secured supercomputer orchestration system 190 to determine that the information handling system 130 or the NPU AI edge computing box 140 is located nearby or in physical contact with information handling system 100 as a true presence sensor system. More specifically, the capacitive sensor 199 may sense physical contact of the information handling system 130 or NPU AI edge computing box 140 within a device stack in an embodiment. In another embodiment, the capacitive sensor 199 may sense physical proximity of the information handling system 130 or NPU AI edge computing box 140 within a device stacking threshold distance of one another, such as for example, one foot, two feet, or up to five feet, when in a stacked configuration with space for venting or proximate to a stacked formation of some of the information handling systems 130 or NPU AI edge computing boxes 140 to be formed into an ad-hoc secured supercomputer cluster. The capacitive sensor 199 may detect capacitive contact or proximity by operation of a capacitive sensing driver controller 191 that is an integrated circuit chip on the information handling system 100, such as a dedicated cluster controlling anchor information handling system 100 (not shown), or an NPU AI edge computing box 140 as discussed further in FIG. 2 for capacitive proximity detection in a stacked configuration in some embodiments or other near proximity configurations. In addition, in embodiments herein, proximity detection may be conducted with the capacitive sensor 199 and a capacitive chassis 196 at information handling system 100, including any NPU AI edge computing boxes 140 as discussed further in FIG. 2 to utilize encoded electrical fields with capacitance detection as another security measurement for true presence sensing of these devices within a stacked configuration or other configuration with proximity of one another in embodiments herein.

In other example embodiments of true presence sensor systems, the hardware processor 102 may execute machine readable code instructions 114 of the ad-hoc secured supercomputer cluster orchestration system 190 to sense the information handling system 130 or NPU AI edge computing box 140 are within a device stacking threshold distance of one another or a user using beam-forming with microphone 172 or 174 and speaker 171 or 173, ultra-wideband (UWB) radio frequency transmissions transceived via wireless interface adapters 120 or 181a, or wireless signal strength indicators for WLAN or Bluetooth ® communications emitted and measured via wireless interface adapters 120 or 181a.

As another example of a true presence sensor system, inertial measurement unit (IMU) 198 may detect jarring or bumping of information handling system 100 that occurred simultaneous to a similar reading from a capacitive sensor 199 at information handling system 130 or similar device at NPU AI Edge computing box 140, as transmitted via the wireless interface adapter 181a and received via the wireless interface adapter 120, indicating a stacking of the information handling system 130 or similar device at NPU AI Edge computing box 140 with the information handling system 100. As another example, the information handling system 100 may perform a wireless handshake using short-range communications with the information handling system 100 or the NPU AI edge computing box 140 that is limited to within short-range communication and thus assures current line-of-sight between the information handling systems 100, 130, and 140. In yet another example embodiment of a true presence sensor system, microphone 172 may detect an audio signal (e.g., as emitted via speaker 171) that occurred simultaneously to a similar reading from a microphone 174 at information handling system 130, as transmitted via the wireless interface adapter 181a and received via the wireless interface adapter 120. Each of these methods may establish physical proximity of the plurality of information handling systems 100, 130, and 140 in a stacked formation either directly atop one another or with minimal spacing between the information handling systems 100, 130, and 140 to allow for heat dissipation according to some embodiments of the present disclosure.

In other embodiments, an ad-hoc secured supercomputer cluster may be formed using a plurality of information handling systems 100, 130, and 140 in dispersed locations within the same space or room and within line-of-sight of a user whose presence has been detected by one or more of the information handling systems 100, 130, or 140. In such a case, a hardware processor 102 may execute machine readable code instructions 114 of the ad-hoc secured supercomputer orchestration system 190 in tandem with global positioning satellite (GPS) sensor 118 to determine that the information handling system 100 has a matching GPS location or GPS locations sufficiently close to that of information handling systems 130 and 140, as recorded by GPS unit 176, transmitted via the wireless interface adapter 181a and received via the wireless interface adapter 120, to indicate that they are in the same room plus confirmation with one or more other true presence sensing modalities of embodiments herein. More specifically, hardware processor 102 may execute machine readable code instructions 114 of the ad-hoc secured supercomputer orchestration system 190 to determine that the information handling system 100 is within threshold true presence distance of information handling systems 130 and 140, such as, for example, ten feet, twelve feet, fifteen feet, or twenty feet. Confirmation of the GPS sensor 118 may be made with microphones 172, cameras, infrared detectors, UWB sensors, or other sensing systems for detecting human presence of the user within line of sight of each of the plurality of information handling systems 100, 130, 140 dispersed within the same space, such as a room.

The hardware processor 102 executing machine readable code instructions 114 of the ad-hoc secure supercomputer cluster orchestration system 190 in an embodiment may receive a detection of the user’s presence from the microphone 172, other IO device 104, such as a camera or infrared detector, UWB sensor, or a combination as a true presence sensor system. Upon detection, via microphone 172 or 174, of the user speaking a clustering trigger phrase aloud, such as “form a cluster,” the hardware processor 102 may execute machine readable code instructions 114 of the ad-hoc secured supercomputer cluster orchestration system 190 to sense the user’s position using beam-forming with microphone 172 or 174 and speaker 171 or 173, ultra-wideband (UWB) radio frequency transmissions transceived via wireless interface adapters 120 or 181a, or wireless signal strength indicators for WLAN or Bluetooth ® communications emitted and measured via wireless interface adapters 120 or 181a, alone or in any combinations as true presence sensor systems. The hardware processor 102 may execute machine readable code instructions 114 of the ad-hoc secured supercomputer cluster orchestration system 190 may also determine physical proximity of the information handling system 130 to the user by receiving a distance and bearing of the user with respect to the information handling system 130 via the wireless interface adapter 120, as measured using beam-forming with a microphone 174 and speaker 173, ultra-wideband (UWB) radio frequency transmissions transceived via wireless interface adapters 181a, wireless signal strength indicators for WLAN or Bluetooth ® communications emitted and measured via wireless interface adapters 181a, or any combination. By identifying the user’s location using such methods, information handling system 100 may establish that the user is in line-of-sight.

Once true presence amongst the information handling systems has been confirmed or line-of-sight with a human user of a plurality of information handling systems is confirmed using the above methodologies, each of the information handling systems 100, 130, and 140 may form an ad-hoc secure supercomputing cluster to perform parallel processing of DNN layers. A hardware processor 102 may execute computer readable code instructions 114 of the ad-hoc secured supercomputer orchestration system 190 to sense at least one information handling system 100 is either located above the other information handling systems 130, 140 in a stack, has an open lid, or is nearest to a speaking user. This at least one information handling system 100 may then transmit its identity as the cluster controlling anchor information handling system to the other information handling systems 130 and 140 that are in true presence of the information handling system 100 or line-of-sight of the user in various embodiments. This may identify the information handling system 100 most likely to be accessible to the user as the controlling device for an automatically formed ad-hoc secured supercomputer cluster. For example, hardware processor 102 may execute computer readable code instructions 114 of the ad-hoc secured supercomputer orchestration system 190 in tandem with capacitive sensors 199 to sense it is a top of stack information handling system 100. In another embodiment, a lid sensor (not shown) may determine that the information handling system 100 has an open laptop lid and the other information handling system 130 has a lid closed or NPU AI edge computing box 140 has not lid for a deployable digital display device 116. In another example, hardware processor 102 may execute computer readable code instructions 114 of the ad-hoc secured supercomputer orchestration system 190 in tandem with GPS unit 118 or in tandem with the microphone 172, speaker 171, or wireless internet adapter 120 performing beam-forming techniques to sense it is nearest to a speaking user, or it is located above the other information handling systems 130, 140.

The wireless interface adapter 120 at the cluster controlling anchor information handling system 100 may work in tandem with all other information handling systems 130 and 140 in true presence of the cluster controlling anchor information handling system 100 to establish secure wireless sideband communication wireless links with the cluster controlling anchor information handling system 100 that are distinct from the previously shared wireless network 124. This may ensure that the communications and commands transmitted from the cluster controlling anchor information handling system 100 to the remaining information handling systems 130 and 140 are secure and cannot be hacked by an individual outside of the room containing all of the information handling systems 100, 130 and 140. All of the information handling systems 100, 130 and 140 may share system capabilities, including processing capacity, audio capabilities, and thermal boundaries with the cluster controlling anchor information handling system 100 via the secure wireless sideband communication wireless links. The hardware processor 102 may execute machine readable code instructions 114 of the ad-hoc secured supercomputer cluster orchestrations system 190 to disable a display 177, non-audio IO devices 178, and operating system 179 of the information handling system 130 and to orchestrate input for a microphone 174 and output for a speaker 173 at the information handling system 130 to minimize echo or interference across the entire cluster.

All information handling systems 130 and 140 in true presence of the cluster controlling anchor information handling system 100 may transmit system metrics to the cluster controlling anchor information handling system 100, including current processor usage, current thermal measurements (e.g., from thermal sensor 162b), and current power measurements. The hardware processor 102 may execute machine readable code instructions 114 of the ad-hoc secured supercomputer orchestration system 190 to determine, based on these received metrics, a balanced distribution of DNN layers for processing at each of the information handling systems 100, 130 and 140 to balance current power, processing, and thermal metrics across each of the information handling systems 100, 130 and 140. The wireless interface adapter 120 may transmit commands via the secure sideband communication wireless links to execute the balanced distribution of DNN layers for processing at each of the information handling systems 130 and 140. Following such a processing, the hardware processor 102 may execute machine readable code instructions 114 of the ad-hoc secured supercomputer orchestration system 190 to aggregate the received DNN layer outputs from the information handling systems 130 and 140. In such a way, an ad-hoc secured supercomputer cluster of information handling systems 100, 130 and 140 may be formed that may include NPU AI edge computing box 140 or currently unused computers, such as 130 that are viewable in line-of-sight of an individual user to enhance security and to increase the available capacity for processing DNN layers across a larger plurality of information handling systems 100, 130 and 140 and hardware processors.

The cluster controlling anchor information handling system 100 may work in tandem with the information handling system 130 and NPU AI Edge computing box 140 previously determined to be in true presence of the cluster controlling anchor information handling system 100 to reconfirm that each of these information handling systems 130 and 140 are still in true presence of one another. For example, the wireless interface adapter 120 may receive from a position-altered information handling system 130 or a position-altered NPU AI edge computing box 140, an updated capacitive sensor measurement indicating lack of physical proximity of the position-altered information handling system 130 or a position-altered NPU AI edge computing box 140 from the information handling system 100 within the device stacking threshold distance. In such a case, the wireless interface adapter 120 may terminate the secured sideband communication wireless link with the position-altered information handling system 130 or a position-altered NPU AI edge computing box 140.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 126, a base station transceiver 125, a wireless telephone, a control system, a camera, a scanner, a printer, a personal trusted device, a smart appliance, an IOT sensor, a vehicle, or any other suitable machine capable of executing a set of instructions (sequential or otherwise) that specify actions to be taken by that machine, and may vary in size, shape, performance, price, and functionality. Information handling system 100 may be any information handling systems or NPU AI edge computing boxes of example embodiments of FIGS. 1-7 described herein.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), a graphics processing unit (GPU) 151, other hardware controllers, or any combination thereof. Additional components of the information handling system 100 may include one or more storage devices such as static memory 105 or drive unit 115. The information handling system 100 may include or interface with one or more communications ports for communicating with external devices, as well as an input/output (IO) device 104, a video/graphics digital display device 116, or any combination thereof. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood that any or all portions of machine readable code instructions (e.g., software or firmware algorithms), parameters, and profiles 114 may operate on a plurality of information handling systems 100.

The information handling system 100 may include the hardware processor 102 such as a central processing unit (CPU) or other hardware processing resources. Any of the hardware processing resources may operate to execute machine readable code instructions 114 that are either firmware or software code. Moreover, the information handling system 100 may include memory such as main memory 103, static memory 105, and disk drive unit 115 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, GPU 151, or any other hardware processing device. The information handling system 100 may also include one or more buses 117 operable to transmit communications between the various hardware components such as any combination of various I/O devices 116, as well as between hardware processors 102, GPU 151 or other, the operating system (OS) 113, the basic input/output system (BIOS) 110, the wireless interface adapter 120, or a radio module 121, among other components described herein.

A network interface device of the information handling system 100 may be wired or wireless such as shown with wireless interface adapter 120 that can provide wireless connectivity among devices such as with Bluetooth® or to a network 124, e.g., a wide area network (WAN), a local area network (LAN), wireless local area network (WLAN), a wireless personal area network (WPAN), a wireless wide area network (WWAN), a virtual private network (VPN) or other network. In embodiments described herein, the wireless interface device 120 with its radio 121, RF front end 122 and antenna 123 is used to communicate with the network 124 and with the wearable 3D IO and authenticator device 160, via, for example, a Bluetooth® or Bluetooth® Low Energy (BLE) protocols, or other WPAN or WLAN protocols.

In an embodiment, a WAN, WWAN, LAN, and WLAN may each include an AP 126 or base station 125 used to operatively couple the information handling system 100 to a network 124 or the wearable 3D IO and authenticator device 160 via a wireless interface adapter 120. In a specific embodiment, the network 124 may include macro-cellular connections via one or more base stations 125 or a wireless AP 126 (e.g., Wi-Fi), or such as through licensed or unlicensed WWAN small cell base stations 125. Connectivity may be via wired or wireless connection. For example, the wearable 3D IO and authenticator device 160, wireless network wireless APs 126 or base stations 125 may be operatively connected to the information handling system 100. Wireless interface adapter 120 may include one or more radio frequency (RF) subsystems (e.g., radio 121) with transmitter/receiver circuitry, modem circuitry, one or more antenna RF front end circuits 122, one or more wireless controller circuits, amplifiers, antennas 123 and other circuitry of the radio 121 such as one or more antenna ports used for wireless communications via multiple radio access technologies (RATs). The radio 121 may communicate with one or more wireless technology protocols.

In an embodiment, the wireless interface adapter 120 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth ® protocols in some embodiments. Wireless interface adapter 120 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 120 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 124 may communicate voice, video, or data over the network 124. Further, the machine readable code instructions 114 may be transmitted or received over the network 124 via the network interface device or wireless interface adapter 120.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 151, or any other hardware processing resource and may include software agents, or other aspects or components used to execute the methods and systems described herein. Various software modules comprising application machine readable code instructions 114 may be coordinated by an OS 113, and/or via an application programming interface (API) include a unified device API described herein. An example OS 113 may include Windows ®, Android ®, and other OS types. Example APIs may include Win 32, Core Java API, or Android APIs.

In an embodiment, the information handling system 100 may include a disk drive unit 115. The disk drive unit 115 and may include machine-readable code instructions, parameters, and profiles 114 in which one or more sets of machine-readable code instructions, parameters, and profiles 114, such as firmware or software can be embedded to be executed by the hardware processor 102 or other hardware processing devices such as a GPU 151, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 115 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 115 during execution by the hardware processor 102, or GPU 151 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 115 that may include access to a machine-readable code instructions, parameters, and profiles 114, such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 115, the hardware processor 102 (e.g., CPU), the GPU 151, the digital display device 116, or other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions or IO commands. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system 100. The system, device, controller, or module can also include a combination of the foregoing examples of hardware or hardware executing software or firmware. Note that an information handling system 100 can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

FIG. 2 is a block diagram of an information handling system forming an ad-hoc secure supercomputing cluster across a plurality of neural processing unit (NPU) artificial intelligence (AI) edge computing boxes determined to be in true presence of one another and an information handling system to perform parallel processing of deep neural network (DNN) layers across the supercomputing cluster according to an embodiment of the present disclosure. As described herein, a hardware processor 202 of an information handling system 200, having IO capabilities such as a display device, may execute machine readable code instructions 214 of the ad-hoc secured supercomputer orchestration system 290 in an embodiment to automatically form an ad-hoc secured supercomputer cluster of information handling systems that may include NPU AI edge computing boxes 241 and 242 that do not have IO devices enabled and have compute cores dedicated to function as NPU AI edge computing boxes 241 and 242. The information handling system 200 and NPU AI edge computing boxes 241 and 242 or other currently unused computers (e.g., 130 from FIG. 1) may be detected within true presence proximity of one another with a true presence sensing system to enhance security and to increase the available capacity for processing DNN layers across a larger plurality of information handling systems 200, 241, 242 and hardware processors 202, 251, 256, and 257 of those information handling systems 200, 241, 242.

The wireless interface adapters 283a and 284a of the NPU AI edge computing boxes 241 and 242, respectively, in an embodiment may establish direct wireless links 276 with antenna 223-1 to information handling system 200 via antennas 283d and 284d, respectively. In an embodiment, the NPU AI edge computing boxes 241 and 242 may be used to communicate with the information handling system 200, via, for example, a Bluetooth® or Bluetooth® Low Energy (BLE) protocols, or other short-range WPAN or WLAN protocols. The NPU AI edge computing boxes 241 and 242 may include one or more radio frequency (RF) subsystems (e.g., short distance radios 283b and 284b) with transmitter/receiver circuitry, modem circuitry, one or more antenna RF front end circuits, such as RF front end 283c or 284c, one or more wireless controller circuits, amplifiers, antennas 283d and 284d and other circuitry of the wireless interface adapters 283a and 284a, respectively, such as one or more antenna ports used for wireless communications via multiple radio access technologies (RATs). The radios 283b and 284b may communicate with one or more wireless technology protocols.

The NPU AI edge computing boxes 241 and 242 in an embodiment may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth ® protocols in some embodiments. The NPU AI edge computing boxes 241 and 242 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums.

The NPU AI edge computing boxes 241 and 242 may include neural processing units (NPUs) 256 and 257 for processing deep neural network (DNN) layers distributed to each of the NPU AI edge computing boxes 242 and 242 by the information handling system 200, as stored within a main memory 241a or 241b or static memory 243a or 243b, respectively. In an embodiment, the NPU AI edge computing boxes 241 and 242 may include the NPUs 256 or 257, respectively, or other hardware processing resources on the NPU AI edge computing boxes 241 and 242. Moreover, the NPU AI edge computing boxes 241 and 242 may include main memory 241a or 241b, or static memory 243a or 243b, respectively such as volatile (e.g., random-access memory, etc.), nonvolatile memory (read-only memory, flash memory etc.) or any combination thereof or other memory with computer readable medium storing machine readable code instructions (e.g., software or firmware algorithms), parameters, and profiles 242a and 242b executable by the NPUs 256 and 257, respectively or any other hardware processing device to perform the processes described herein. Memory 242a or 242b or static memory 243a or 243b or other memory of the embodiments described herein may contain computer-readable medium 244a and 244b, respectively, such as RAM in an example embodiment. In an embodiment, main memory 242a or 242b or static memory 243a or 243b may contain computer-readable medium 244a and 244b, such as NOR or NAND flash memory in some example embodiments. Another example of main memory 242a or 242b or static memory 243a or 243b includes random access memory (RAM) such as static RAM (SRAM), dynamic RAM (DRAM), non-volatile RAM (NV-RAM), or the like, as well as read only memory (ROM), another type of memory, or a combination thereof in other embodiments herein.

In an embodiment, the NPU AI edge computing boxes 241 and 242 may further include box power management units (PMUs) 247a and 247b, respectively (a.k.a. a power supply unit (PSU)). The box PMUs 247a and 247b may include a hardware controller and executable machine-readable code instructions to monitor and manage the power provided to the components of the NPU AI edge computing boxes 241 and 242, respectively and other hardware components described herein. The box PMUs 247a and 247b may control power to one or more components including the one or more drive units 243a and 243b, the NPUs 256 and 257, capacitive sensors 245a and 245b, wireless interface adapters 283a and 284a, or other components that may require power when a power button has been actuated by a user. In an embodiment, the box PMUs 247a and 247b may monitor power levels and be electrically coupled to the NPU AI edge computing boxes 241 and 242, respectively to provide this power. The box PMUs 247a and 247b may regulate power from a power source such as the batteries 248a and 248b, respectively, or AC power adapters 249a and 249b, respectively. In an embodiment, the batteries 248a and 248b may be charged via the AC power adapters 249a and 249b, respectively, and provide power to the components of the NPU AI edge computing boxes 241 and 242, respectively, via wired connections as applicable, or when AC power from the AC power adapters 249a and 249b is removed.

In embodiments of the present example, power from the batteries 248a or 248b or AC power adapters 249a or 249b may be transferred, under control of the capacitive sensing driver controllers 243a and 243b, to capacitive chasses 246a and 246b, respectively, to utilized capacitive proximity detection by capacitive sensing driver controllers 241a and 241b with capacitive sensors 245a and 245b of the NPU AI edge computing box devices 241 and 242 for confirmation of true presence among those devices shown in FIG. 2. Similarly, a capacitive sensor 299 and capacitive sensing driver controller 291 of the information handling system 200 may be used for capacitive proximity sensing of the NPU AI edge computing box devices 241 and 242 in some embodiments. In yet other embodiments, the NPU AI edge computing box devices 241 and 242 may be stacked while other types of proximity sensors may be used to detect proximity of information handling system 200 to the stack.

In another embodiment, one or both of the capacitive sensing driver controllers 243a and 243b may generate an encoded electrical field (e-field) at one or more of the NPU AI edge computing boxes 241 and 242 that may be transmitted from or exchanged among capacitive chasses 246a and 246b as well as capacitive sensors 245a and 245b for confirmation of true presence of these NPU AI edge computing box devices 241 and 242 with one another. Such an encoded e-field may also be exchanged with capacitive chassis 296 or capacitive sensor 299 of the information handling system 200 from the capacitive chasses 246a or 246b and capacitive sensors 245a and 245b of the NPU AI edge computing box devices 241 and 242 for confirmation of true presence among those devices shown in FIG. 2. In another embodiment, a capacitive sensing driver controller 291 may drive the capacitive chassis 296 of the information handling system 200 to generate an encoded electrical field (e-field) that may be exchanged with the NPU AI edge computing boxes 241 and 242. Further, the capacitive sensing driver controller 291 may drive capacitive sensor 299 to detect an encoded electrical field (e-field) that may be exchanged from the NPU AI edge computing boxes 241 and 242 in other embodiments. In such a way, confirmation of true presence of these NPU AI edge computing box devices 241 and 242 with one another and with information handling system 200 may be conducted according to embodiments herein.

The hardware processor 202, in an embodiment may perform a method of determining that the information handling system 200 and NPU AI edge computing boxes 241 and 242 are in true presence of one another in their current positional configuration, such as stacked or within proximity, with respect to one another. This may heighten security of the supercomputing cluster formed through wireless communication, via wireless interface adapters 220, 283a and 284a among information handling system 200 and NPU AI edge computing boxes 241 and 242, respectively by inhibiting physical tampering with information handling system 200 and NPU AI edge computing boxes 241 and 242 by an unauthorized user due to presence of the user of the anchor information handling system 200. Presence of information handling system 200 and NPU AI edge computing boxes 241 and 242 within capacitive proximity of one another in a stacked configuration or other proximity configuration in embodiments herein may be determined using various techniques including with capacitive proximity detection with capacitive sensors 245a and 245b of NPU AI edge computing devices 241 and 242, respectively, or capacitive sensor 299 of information handling system 200. In further embodiments, one or more information handling systems 200 may be detected as within a threshold proximity of a stack by other true presence proximity sensors according to other embodiments described herein.

In another example embodiment, true presence of information handling system 200 and NPU AI edge computing boxes 241 and 242 within capacitive proximity of one another in a stacked configuration or other proximity configuration in embodiments herein may be determined using encoded e-field exchange from a capacitive sensing driver controller 241a, 241b and detected by a capacitive sensors 245a, 245b, and in some embodiments 299, as described in embodiments herein. In another example embodiment, stacked or proximity of the true presence of information handling system 200 and NPU AI edge computing boxes 241 and 242 be determined from performance of a wireless handshake using short-range communications with NPU AI edge computing boxes 241 and 242 that is only possible within short-range communication and thus assures stacking or threshold proximity between the information handling system 200 and NPU AI edge computing boxes 241 and 242. In an example embodiment, the hardware processor 202 executing machine readable code instructions 214 of the ad-hoc secure supercomputer orchestration system 290 may determine that measurements of capacitive sensors 245a and 245b from NPU AI edge computing devices 241 and 242, respectively, indicate a stacked configuration based on capacitive proximity detection by capacitive sensors 245a and 245b as well as capacitive sensor 299 of information handling system 200 from the stack or threshold proximity to the stack in other embodiments described herein.

In one example embodiment, the hardware processor 202 executing machine readable code instructions 214 of the ad-hoc secure supercomputer orchestration system 290 may determine that measurements of capacitive sensors 245a and 245b from NPU AI edge computing devices 241 and 242, respectively, indicate matching encoded electrical fields generated by one or more capacitive chasses 246a and 246b as received at information handling system 200 from wireless interface adapters 283a and 284a, respectively. In yet another example embodiment, the hardware processor 202 executing machine readable code instructions 214 of the ad-hoc secure supercomputer orchestration system 290 may determine that measurements of capacitive sensor 299 at the anchor information handling system 200 and capacitive sensors 245a and 245b from NPU AI edge computing devices 241 and 242, respectively, indicate matching encoded electrical fields generated by one or more capacitive chasses 246a and 246b. In yet another embodiment, a capacitive chassis 296 at the anchor information handling system 200 may generate encoded electrical fields for sensing at capacitive sensors 245a and 245b from NPU AI edge computing devices 241 and 242 for matching that is transmitted to the anchor information handling system 200 for real presence confirmations. These encoded electrical fields may have a relatively short range, such as 0 to 5 feet or less in various embodiments, ensuring proximity for a true presence sensing system and for security purposes in embodiments herein.

Once true presence between the information handling system 200 and NPU AI edge computing boxes 241 and 242 has been confirmed using the above methodologies, information handling system 200 and NPU AI edge computing boxes 241 and 242 may trigger formation of an ad-hoc secure supercomputing cluster to perform parallel processing of DNN layers. A hardware processor 202 at the anchor information handling system 200 may execute computer readable code instructions of the ad-hoc secured supercomputer orchestration system 290 to sense it has an open lid, or it is located above the NPU AI edge computing boxes 241 and 242, and transmit its identity as the cluster controlling anchor information handling system to the NPU AI edge computing boxes 241 and 242 that are in true presence of the information handling system 200. In another embodiment, the information handling system 200 may transmit the identity as the cluster controlling anchor information handling system to the NPU AI edge computing boxes 241 and 242 based solely on identification of the NPU AI edge computing boxes 241 and 242 as NPU edge computing boxes where no other information handling system with interface capabilities is present. This may identify the information handling system 200 most likely to be accessible to the user as the cluster controlling anchor information handling system 200.

The wireless interface adapter 220 at the cluster controlling information handling system 200 may work in tandem with NPU AI edge computing boxes 241 and 242 in true presence of the cluster controlling anchor information handling system 200 to establish secure wireless sideband communication wireless links with the cluster controlling anchor information handling system 200 that are distinct from the previously shared wireless network (e.g., 124 of FIG. 1). This may ensure that the communications and commands transmitted from the cluster controlling anchor information handling system 200 to the NPU AI edge computing boxes 241 and 242 are secure and cannot be hacked by an individual outside of the room containing information handling system 200 and NPU AI edge computing boxes 241 and 242. Cluster controlling anchor information handling system 200 and NPU AI edge computing boxes 241 and 242 may share system capabilities, including processing capacity, and thermal boundaries via the secure wireless sideband communication wireless links with the cluster controlling anchor information handling system 200 which may assess and determine adjustments among the ad-hoc secure supercomputing cluster performing parallel processing of DNN layers according to embodiments herein.

NPU AI edge computing boxes 241 and 242 in true presence of the cluster controlling anchor information handling system 200 may transmit system metrics to the cluster controlling anchor information handling system 200, including current processor usage, current thermal measurements, as measured by thermal sensors 263a and 263b, respectively, and current power measurements as measured at PMUs 247a and 247b, respectively. The hardware processor 202 may execute machine readable code instructions of the ad-hoc secured supercomputer orchestration system 290 to determine, based on these received metrics, a balanced distribution of DNN layers for processing at each of the information handling system 200 and NPU AI edge computing boxes 241 and 242 to balance current power, processing, and thermal metrics across information handling system 200 and NPU AI edge computing boxes 241 and 242. The wireless interface adapter 220 may transmit commands via the secure sideband communication wireless links to execute the balanced distribution of DNN layers for processing at each of the NPU AI edge computing boxes 241 and 242. Following such distributed parallel processing, the hardware processor 202 may execute machine readable code instructions of the ad-hoc secured supercomputer orchestration system 290 to aggregate the received DNN layer outputs from the NPU AI edge computing boxes 241 and 242. In such a way, an ad-hoc secured supercomputer cluster of information handling system 200 and NPU AI edge computing boxes 241 and 242 may be automatically formed and coordinated in performance capabilities that are within true presence sensing proximity of one another. This provides enhanced security and to increase the available capacity for processing DNN layers across an anchor information handling system 200 and NPU AI edge computing boxes 241 and 242 and hardware processors.

The cluster controlling anchor information handling system 200 may work in tandem with the NPU AI Edge computing boxes 241 and 242 previously determined to be in true presence of the cluster controlling anchor information handling system 200 to reconfirm that each of these NPU AI Edge computing boxes 241 and 242 are still in true presence of one another and the information handling system 200. In one example embodiment, the wireless interface adapter 220 may receive from NPU AI edge computing box 241 an updated capacitive sensor measurement from capacitive sensor 245a indicating that the encoded electrical field from NPU AI edge computing box 242 is no longer received. In another example embodiment, the capacitive sensor 299 and capacitive sensing driver controller 291 integrated circuit chip may detect an updated capacitive sensor measurement from capacitive sensor 299 that the encoded electrical field from NPU AI edge computing box 242 is no longer being received at the anchor information handling system 200. In such example embodiments, the wireless interface adapter 220 may terminate the secured sideband communication wireless link with the NPU AI edge computing box 242.

In another example embodiment, the wireless interface adapter 220 may receive from NPU AI Edge computing box 241 an updated capacitive sensor measurement from capacitive sensor 245a indicating sensing of a second encoded electrical field from NPU AI edge computing box 242 that does not match expected encoding or does not match the encoded electrical field generated by capacitive chassis 246a of the NPU AI edge computing box 241. In another example embodiment, the capacitive sensor 299 and capacitive sensing driver controller 291 integrated circuit chip may detect an updated capacitive sensor measurement from a second encoded electrical field from NPU AI edge computing box 242 that does not match expected encoding or match an encoded electrical field generated by capacitive chassis 296 of the anchor information handling system 200. In such example embodiments, the wireless interface adapter 220 may terminate the secured sideband communication wireless link with the NPU AI edge computing box 242. In such a way, it may be possible to establish new secure sideband communication wireless links among a new group of information handling systems that excludes the NPU AI edge computing box 242 determined to no longer be in true presence of the information handling system 200 and NPU AI edge computing box 241 forming the previous cluster.

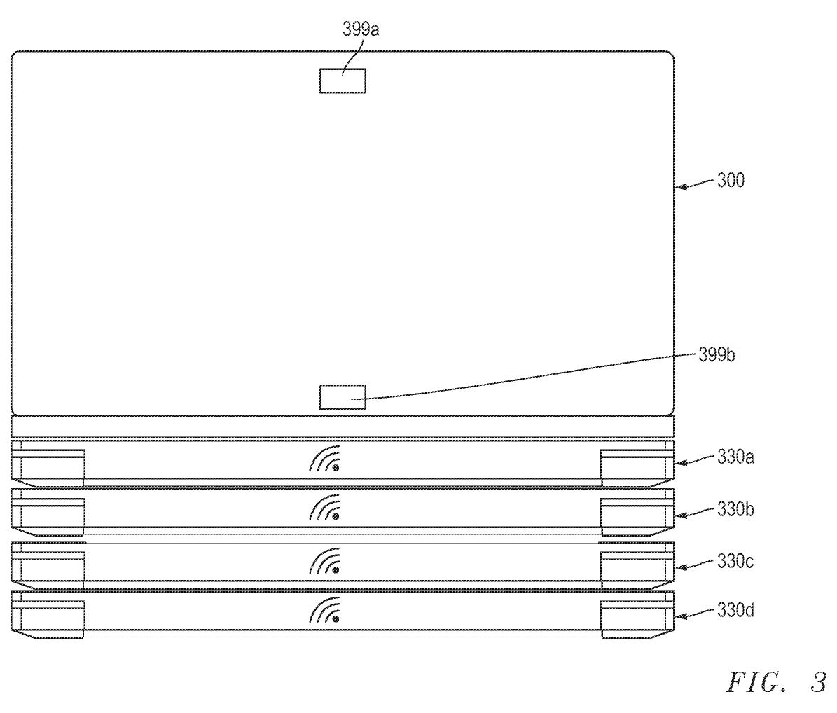

FIG. 3 is a graphical diagram illustrating a plurality of information handling systems in a stacked position, or located within a device threshold stacking distance of one another to establish true presence with one another according to an embodiment of the present disclosure. As described herein, the hardware processors across a plurality of information handling systems, including a cluster controlling information handling system 300, information handling system 330a, information handling system 330b, information handling system 330c, and information handling system 330d, may perform a method of determining that the plurality of information handling systems 300, 330a, 330b, 330c, and 330d are in true presence of one another in their current positional configuration with respect to one another. True presence may be determined from one or more types of true presence detector systems. This may heighten security of the supercomputing cluster formed through wireless communication among these information handling systems 300, 330a, 330b, 330c, and 330d by inhibiting physical tampering with these devices by an unauthorized user.

In one example embodiment of a true presence sensor system utilizes one or more capacitive sensors 399a and 399b disposed on a lid chassis of each information handling system 300, 330a, 330b, 330c, and 330d in an embodiment. In other embodiments, capacitive sensors 399a and 399b may be disposed on a bottom surface of a base chassis (not shown) of each information handling system 300, 330a, 330b, 330c, and 330d in addition to or instead of on the lid chassis as shown. For example, capacitive sensors 399a and 399b at the one or more of the plurality of information handling systems 300, 330a, 330b, 330c, and 330d may work in tandem with hardware processors at those information handling systems 300, 330a, 330b, 330c, and 330d executing machine readable code instructions of an ad-hoc secured supercomputer orchestration system to determine whether the information handling systems 300, 330a, 330b, 330c, and 330d are stacked in physical contact, as shown in FIG. 3, or in stacked proximity with one another. In one embodiment, the capacitive sensors 399a and 399b of the top information handling system 300 in the stack may detect no additional information handling system above to determine it is the top-of-stack information handling system 300. This is used by the ad-hoc secured supercomputer orchestration system to designate top-of-stack information handling system 300 as a cluster controlling anchor information handling system 300 for the automatically formed ad-hoc secured supercomputer cluster in an embodiment.

In another embodiment, a lid sensor may detect the configuration of the information handling systems 330a, 330b, 330c, and 330d are in a closed lid configuration, thus activating the capacitive sensors 399a and 399b on each of those systems to detect a stacked information handling system above. The lid sensor may detect the top information handling system 300 is in an open configuration and the top information handling system 300 may be designated as a cluster controlling anchor information handling system 300 of the stacked set of information handling systems 300, 330a, 330b, 330c, and 330d in some embodiments.

In some embodiments, when such physical proximity or stacking is detected, one or more of the information handling systems 300, 330a, 330b, 330c, and 330d may further confirm such physical proximity or stacking via other types of sensors as a true presence sensor system. For example, inertial measurement units at the plurality of information handling systems 300, 330a, 330b, 330c, and 330d may be used at least two of the information handling systems (e.g., 300 and 330a, 330a and 330b, 330b and 330c, or 330c and 33d) to detect simultaneous jarring or bumping of those devices that may occur as those information handling systems are placed in physical contact with one another. One or more of these inertial measurement units may operate to confirm capacitance detection described in embodiments above for confirming stacking as a true presence sensor system. As another example, each of the information handling systems 300, 330a, 330b, 330c, and 330d may perform a wireless handshake using short-range communications with one another to establish that each of the information handling systems 300, 330a, 330b, 330c, and 330d is within short-range communication and is thus capable of being in line-of-sight of the user in their current positional configuration. In yet another example, each of the information handling systems 300, 330a, 330b, 330c, and 330d may determine that the plurality of information handling systems 300, 330a, 330b, 330c, and 330d simultaneously detect the same emitted audio signal to confirm that there are no physical obstructions such as walls or windows between the information handling systems 300, 330a, 330b, 330c, and 330d that may break line-of-sight between the user and each of the information handling systems 300, 330a, 330b, 330c, and 330d. These above sensor systems may be individually used as a true presence sensor system or may be combined, for example with the capacitance detection described in embodiments above for confirming stacking as a combined true presence sensor system in embodiments herein.

Once the cluster control anchor information handling system 300 is designated, the other information handling systems 330a, 330b, 330c, and 330d, such as in the stack, have IO devices and other processing disabled or some IO devices, such as microphones or cameras are coordinated with the cluster control anchor information handling system in embodiments herein. Further, the computing cores of information handling systems 330a, 330b, 330c, and 330d are dedicated to parallel processing with the cluster control anchor information handling system 300 as the ad-hoc secure supercomputing cluster in embodiments herein and not used for other purposes, effectively transforming them into NPU AI edge computing boxes of embodiments herein.

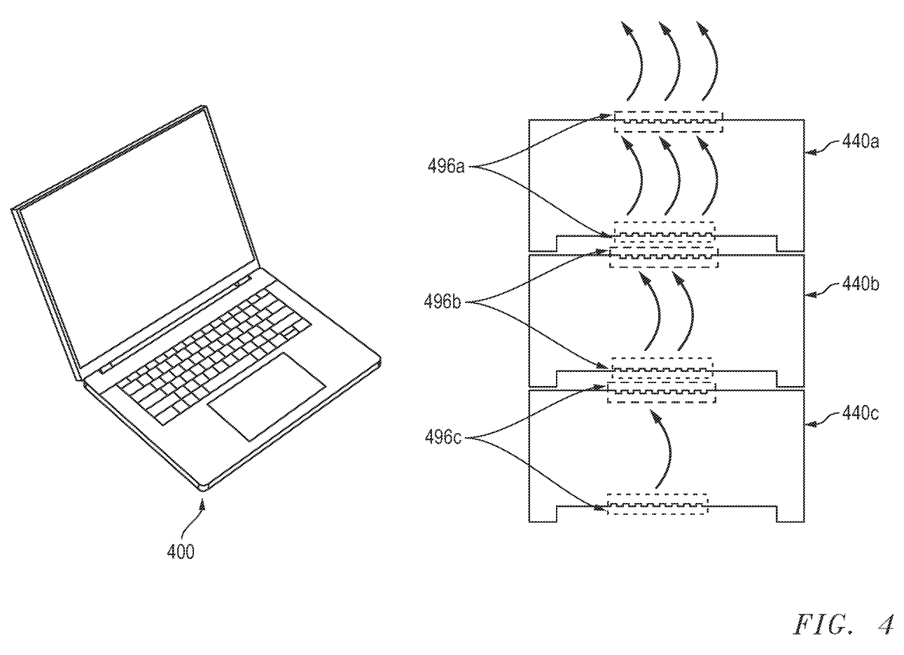

FIG. 4 is a graphical diagram illustrating an information handling system in true presence of a stacked configuration of neural processing unit (NPU) artificial intelligence (AI) edge computing boxes for forming an ad-hoc secure supercomputing cluster according to another embodiment of the present disclosure. As described herein, in an embodiment, at least a portion of the plurality of information handling systems are NPU AI edge computing boxes, such as 440a, 440b, and 440c that slotted and stacked to form an ad-hoc secure supercomputing cluster. In an embodiments, the ad-hoc secure supercomputer cluster may involve an anchor information handing system 400 or one or more unused information handling systems (e.g. 130 of FIG. 1 above) within a physical proximity range of a stacked plurality of NPU AI edge computing boxes 440a, 440b, and 440c having dedicated processing cores as described above. True presence sensing in an embodiment, may be conducted via capacitive proximity sensing of NPU AI edge computing boxes 440a, 440b, and 440c detect with capacitive sensors that they are in capacitive proximity to one another. In another embodiment, NPU AI edge computing boxes 440a, 440b, and 440c may determine that at least one capacitors, such as capacitive chassis, for at least one of the NPU AI edge computing boxes 440a, 440b, and 440c is emitting and all NPU AI edge computing boxes 440a, 440b, and 440c are detecting the same encoded electrical field (e-field) as one another when in capacitive proximity. Operation of this system is described in various embodiments, for example, with respect to FIG. 2 above. Further, proximity of the cluster controlling anchor information handling system 400 may be detected relative to the stack in embodiments such as those described above in FIG. 2 and elsewhere herein.

Each of NPU AI edge computing boxes 440a, 440b, and 440c may include upper and lower air circulation vents 496a, 496b, and 496c, respectively. When placed in a stacked configuration, these upper and lower air circulation vents 496a, 496b, and 496c may line up with one another, and the air circulated from the NPU AI edge computing box below may vent directly into the NPU AI Edge computing box above to create a chimney effect and further enhance cooling amongst the NPU AI edge computing boxes 440a, 440b, and 440c and any cluster control anchor information handling system if it is also stacked. Moreover, thermal proximity may be shared to assist cooler stacked NPU AI edge computing boxes 440a, 440b, and 440c, or other stacked information handling systems (e.g., 300, 330a, 330b, 330c, and 330d of FIG. 3 above) to provide thermal cooling to higher heat generating NPU AI edge computing boxes 440a, 440b, and 440c (or stacked information handling systems.

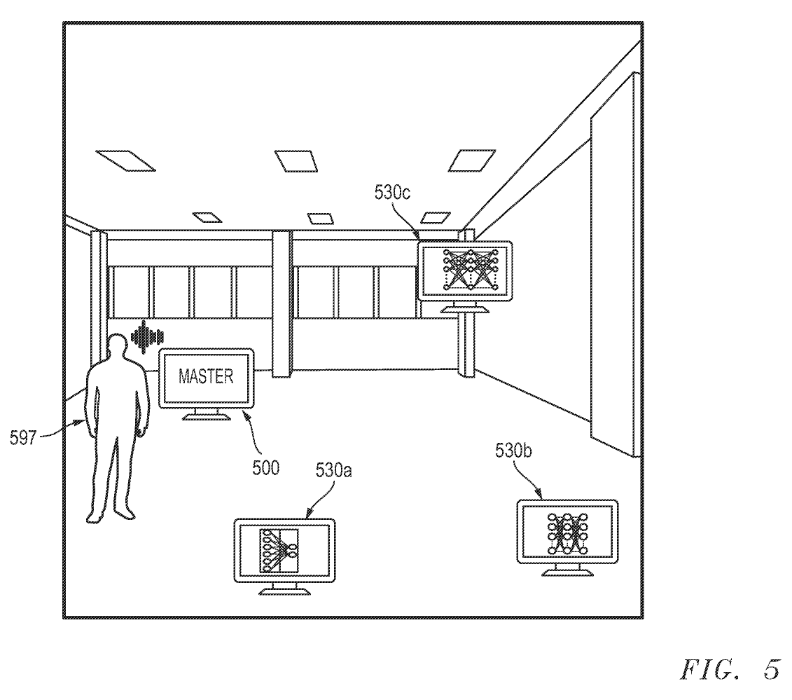

FIG. 5 is a graphical diagram illustrating a plurality of information handling systems in a disbursed configuration, located within the same room and within line-of sight of a detected user to establish true presence using one or more true presence sensor systems according to an embodiment of the present disclosure. As described herein, an ad-hoc secured supercomputer cluster may be formed using a plurality of information handling systems 500, 530a, 530b, and 530c in dispersed locations within the same room and within line-of-sight of a user 597 whose presence has been detected by one or more of the information handling systems 500, 530a, 530b, and 530c. In such a case, hardware processors of least one of the information handling systems 500, 530a, 530b, and 530c may execute machine readable code instructions of the ad-hoc secured supercomputer orchestration system in tandem with global positioning satellite (GPS) sensors plus additional proximity sensors, cameras, microphones or the like to determine that the information handling systems 500, 530a, 530b, and 530c have matching GPS locations or GPS locations sufficiently close to one another to indicate that they are in the same room and to identify the human presence of the user 597 within the same room. In other words, GPS sensors at each of the information handling systems 500, 530a, 530b, and 530c may determine that the information handling systems 500, 530a, 530b, and 530c are all within a threshold true presence distance of each other, such as for example, up to ten feet, twelve feet, fifteen feet, or twenty feet and then another true presence sensing modality is used to determine the presence of the user 597 within line of sight of the plurality of information handling systems.

In one example embodiment, upon detection of the user 597 speaking a clustering trigger phrase aloud, such as “form a cluster,” each information handling system 500, 530a, 530b, and 530c may sense the users 597 position using beam-forming with microphones and speakers, using cameras, using ultra-wideband (UWB) radio frequency transmissions, using wireless signal strength indicators for WLAN or Bluetooth ® communications such as Wi-Fi sensing, or using another proximity sensing system. By identifying the user’s location, each information handling system 500, 530a, 530b, and 530c may report or determine position relative to that user 597 with such true presence sensor systems. First, this may establish that the user is in line-of-sight of each information handling system 500, 530a, 530b, and 530c that may be incorporated automatically into an ad-hoc secure supercomputer cluster. In a further embodiment, a closest information handling system from among 500, 530a, 530b, and 530c or one having a laptop lid open and engaged with, may be designated as a cluster control anchor information handling system, for example information handling system 500. Each of the other information handling systems 530a, 530b, and 530c in such as case may have IO devices and other software applications disabled and have processing cores dedicated to the ad-hoc secure supercomputing cluster automatically formed in embodiments herein. This may transform the other information handling systems 530a, 530b, and 530c into dedicated processing cores according to some embodiments herein. The cluster control anchor information handling system 500 may establish the secured wireless interfaces with each of the other dedicated information handling systems 530a, 530b, and 530c as the ad-hoc secure supercomputing cluster for parallel processing as described in embodiments herein.

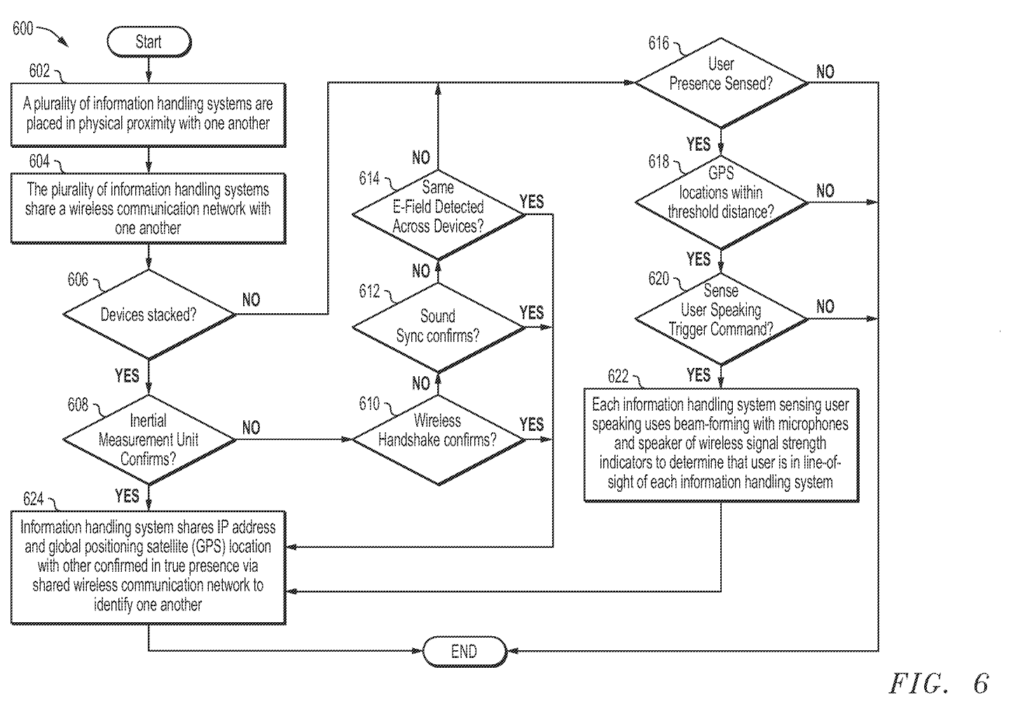

FIG. 6 is a flow diagram illustrating a method of determining that a plurality of information handling systems are in true presence of one another or are capable of being in line-of-sight of an individual user via one or more true presence sensing systems according to plural embodiments of the present disclosure. As described herein, the ad-hoc secured supercomputer orchestration system may automatically form an ad-hoc secured supercomputer cluster of information handling systems that may include neural processing unit (NPU) artificial intelligence (AI) edge computing boxes or currently unused computers that are detected as stacked or within stacked proximity of one another in some embodiments. In another embodiment, the ad-hoc secured supercomputer orchestration system may automatically form an ad-hoc secured supercomputer cluster of information handling systems that may include neural processing unit (NPU) artificial intelligence (AI) edge computing boxes or currently unused computers that are detected viewable in line-of-sight of an individual user. Execution of an ad-hoc secured supercomputer orchestration system uses one or more true presence sensing systems of the embodiments of FIG. 6 to enhance security and to increase the available capacity for parallel processing deep neural network (DNN) layers across a larger plurality of information handling systems and hardware processors. The hardware processors across such a plurality of information handling systems in embodiments here may perform a method of determining that the plurality of information handling systems are in true presence of one another in their current positional configuration, or are capable of being in line-of-sight of an individual user via use of one or more true presence sensing systems of embodiments herein. This may heighten security of the supercomputing cluster formed through wireless communication among these information handling systems by inhibiting physical tampering with these devices by an unauthorized user.

At block 602, a plurality of information handling systems may be placed in physical proximity with one another in an embodiment. For example, a plurality of information handling systems may be placed in a stacked configuration, such as shown in FIG. 3, in a first embodiment. As another example, an information handling system may be placed in physical proximity of one or more stacked NPU AI edge computing boxes or unused information handling systems, as shown in FIG. 4, a second embodiment. In a third embodiment, a plurality of information handling systems may be dispersed through a single room in which an individual user has been detected, as shown in FIG. 5.

The plurality of information handling systems in an embodiment at block 604 may share a wireless communication network with one another. For example, each of the information handling systems, which may include NPU AI edge computing boxes, may share the same WLAN or Wi-Fi network. In other embodiments, the information handling systems may share the same LAN, WAN, WWAN, WPAN, PAN, or near-field communication network.

At block 606, capacitive sensors at one or more of the plurality of information handling systems in proximity with one another may work in tandem with hardware processors at those information handling systems executing machine readable code instructions of an ad-hoc secured supercomputer orchestration system to determine whether the information handling systems are stacked with one another according to the first embodiment or are in stacked configuration with stacked capacitive proximity to one another as in the second embodiment. For example, capacitive sensors at one or more of the plurality of information handling systems may work in tandem with hardware processors at those information handling systems executing machine readable code instructions of an ad-hoc secured supercomputer orchestration system to determine whether the information handling systems are stacked in physical contact on top of one another via a capacitive sensors at the plurality of information handling systems as a true presence sensing system similar to the embodiment shown in FIG. 3. The capacitive sensors may be disposed on a display chassis lid cover or bottom of a base chassis to detecting the stacked information handling systems in a stacked configuration.

As another example embodiment described with respect as second embodiment of FIGS. 2 and 4, a hardware processor may execute machine readable code instructions of the ad-hoc secured supercomputer cluster orchestration system to sense the information handling system or NPU AI edge computing boxes within a device stacking threshold distance of one another using capacitive sensors to detect capacitive proximity with one another. In another embodiment, another proximity sensor may be used to detect proximity of the cluster controlling anchor information handling system to the stacked NPU AI edge computing boxes or unused information handling systems in embodiments herein.

If the information handling systems are stacked as in the first embodiment of FIG. 3 or are within true presence proximity of a stack of NPU AI edge computing boxes or unused information handling systems and one another as in the second embodiment of FIG. 4 at block 606, the method may proceed to block 608 for further confirmation of true presence of the information handling systems. If the information handling systems are not stacked physical contact as in the first embodiment of FIG. 3 or are within true presence proximity of a stack of NPU AI edge computing boxes or unused information handling systems and one another as in the second embodiment of FIG. 4 at block 606, the method may proceed to block 616 to determine whether other sensors indicate true presence of the information handling systems within the same room in line-of-sight with a user.

In some embodiments, additional sensor types may be used as part of or as the true presence sensing system. At block 608, inertial measurement units at the plurality of information handling systems in an embodiment may work in tandem with hardware processors at those information handling systems executing machine readable code instructions of an ad-hoc secured supercomputer orchestration system to determine whether the information handling systems are stacked in physical contact as in the embodiment of FIG. 3 or stacked within capacitive proximity as in the embodiment of FIG. 4 with one another as part of the true presence sensing system. For example, inertial measurement units at the plurality of information handling systems may be used with at least two of the information handling systems to detect simultaneous jarring or bumping of those devices that may occur as those information handling systems are placed in physical contact with one another in an embodiment. In another embodiment, an inertial measurement unit for at least one information handling system may be used to detect simultaneous jarring or bumping of that device with a capacitive sensor detecting contact or proximity between two information handling systems upon stacking. If the inertial measurement unit or units at one or the plurality of information handling systems do not confirm that the information handling systems are stacked in physical contact and proximity with one another, the method may proceed to block 610 for a different confirmation of true presence that the information handling systems or any NPU AI edge computing boxes are in proximity with one another. If the inertial measurement units at the plurality of information handling systems confirm that the information handling systems are stacked in physical contact with one another, this may indicate that the information handling systems are in true presence of one another and the method may proceed to block 624 to form an ad-hoc secured supercomputer cluster. In one optional embodiment of FIG. 3, if the capacitive sensors detect physical proximity indicating all information handling systems are stacked at block 606 and additional confirmation is not needed as in block 608, then the method may proceed to block 624.

At block 610 hardware processors at the information handling systems may execute machine readable code instructions of an ad-hoc secured supercomputer orchestration system to perform a wireless handshake using short-range communications with one another to establish true presence and that each of the information handling systems is in true presence proximity in their current positional configuration in an embodiment. For example, each of the information handling systems may perform a wireless handshake using short-range communications with one another to establish that each of the information handling systems is within short-range communication and is thus capable of being in line-of-sight of the user in their current positional configuration in an embodiment. In an example embodiment of FIG. 4, the information handling system 400 may use a short-range wireless handshake with the stack of NPU AI edge computing boxes 440a, 440b, or 440c to determine proximity for automatically forming an ad-hoc secured supercomputer cluster. If the information handling systems successfully perform a wireless handshake using short-range communications with one another, the method may proceed to block 624 to form an ad-hoc secured supercomputer cluster. If the information handling systems do not successfully perform a wireless handshake using short-range communications with one another, the method may proceed to block 612 for a different confirmation of true presence that the information handling systems or any NPU AI edge computing boxes are in proximity with one another using sound synchronization.

Hardware processors at the information handling systems in an embodiment at block 612 may execute machine readable code instructions of an ad-hoc secured supercomputer orchestration system to determine that the plurality of information handling systems simultaneously detect the same emitted audio signal to confirm that the information handling systems or any NPU AI edge computing boxes are in proximity with one another. If the information handling systems successfully confirm reception of simultaneous audio confirmation, the method may proceed to block 624 to form an ad-hoc secured supercomputer cluster. If the information handling systems do not successfully confirm reception of simultaneous audio confirmation, the method may proceed to block 614 for a different confirmation of true presence that the information handling systems or any NPU AI edge computing boxes are in proximity with one another via a capacitive chassis encoded electric field detection.

At block 614, hardware processors at the information handling systems may execute machine readable code instructions of an ad-hoc secured supercomputer orchestration system to determine that capacitors, such as a capacitive chassis driven by a capacitive sensing driver controller integrated circuit, at one or more NPU AI edge computing boxes or information handling systems are emitting or receiving the same encoded electrical field (e-field) as one another via detection with capacitive sensors. For example, as described in an embodiment with respect to FIG. 2, the hardware processor 202 executing machine readable code instructions 214 of the ad-hoc secure supercomputer orchestration system 290 may determine that measurements of capacitive sensors 245a and 245b from NPU AI edge computing devices 241 and 242, respectively, as received from wireless interface adapters 283a and 284a, respectively, indicate matching electrical fields generated by at least one of the capacitive chasses 246a and 246b are detected by capacitive sensors 245a and 245b. Further, the information handling system may have capacitive sensor 299 to detect this encoded electrical field as well in some embodiments. The encoded electrical field has limited range, such as up to five feet. The information handling systems determine that capacitive sensors at each information handling system are detecting the same emitted encoded electrical field as one another at the ad-hoc secure supercomputer orchestration system 290 in an embodiment. When this system operates as a true presence sensing system to confirm true presence proximity between the NPU AI edge computing boxes or information handling systems with each other in their current positional configuration based on the encoded electrical fields, the method proceeds to block 624 to form an ad-hoc secured supercomputer cluster. If the information handling systems determine that capacitors at each information handling system are not detecting the same emitted encoded electrical field as one another, the method may proceed to block 616 to determine whether other sensors indicate true presence of the information handling systems within line-of-sight of the user in the same room based on their current positions.

Hardware processors at the information handling systems in an embodiment at block 616 may execute machine readable code instructions of an ad-hoc secured supercomputer orchestration system in tandem with various sensors to detect whether a user is present within line-of-sight, such as in the same room, with one or more information handling systems that may form an ad-hoc secured supercomputer cluster. For example, in an embodiment described with reference to FIG. 1, the hardware processor 102 executing machine readable code instructions 114 of the ad-hoc secure supercomputer cluster orchestration system 190 in an embodiment may receive a detection of the user’s presence from the microphone 172 or other IO device 104, such as a camera or infrared detector, or a combination as part of or as a true presence sensing system. If not user presence is detectable within line of sight, then the method may end.

If a user is detected as being present within the same room as at least one of the information handling systems in an embodiment, the method may proceed to block 618. If a user is not detected as being present within the same room as at least one of the information handling systems at block 616, this may indicate that the information handling systems are not in true presence with one another or that the information handling systems are not capable of being in line-of-sight of the user in their current positional configuration such that they are not set up to form a supercomputing cluster. In such a case, the method for determining that a plurality of information handling systems are in true presence of one another may then end.

At block 618, hardware processors at the information handling systems in an embodiment in which a user has been detected as being present by at least one information handling system may execute machine readable code instructions of an ad-hoc secured supercomputer orchestration system in tandem with GPS sensors at each of the plurality of information handling systems to detect whether the information handling systems are all located within a GPS distance of one another. The hardware processor 102 may execute machine readable code instructions 114 of the ad-hoc secured supercomputer orchestration system 190 in tandem with global positioning satellite (GPS) sensor 118 to determine that the information handling system 100 has a matching GPS location or GPS locations sufficiently close to that of information handling systems 130 and 140, as recorded by GPS unit 176, transmitted via the wireless interface adapter 181a and received via the wireless interface adapter 120, to indicate that they may be in the same room. More specifically, hardware processor 102 may execute machine readable code instructions 114 of the ad-hoc secured supercomputer orchestration system 190 to determine that the information handling system 100 is within a GPS distance of information handling systems 130 and 140, such as, for example, ten feet, twelve feet, fifteen feet, or twenty feet. If the information handling systems are all located within a threshold GPS distance of one another, this may indicate that those information handling systems may be in within line-of-sight of a detected individual user in their current positional configurations, and the method may proceed to block 620 to determine a location of the user. If the information handling systems are not all located within a threshold GPS distance of one another, those information handling systems outside the GPS distance may not be sufficiently close and may not be secure. In the latter case, the method may then end. In other embodiments, the step of GPS location detection at block 618 may not be performed and the method may proceed to block 620 for user location detection.

In an embodiment in which the plurality of information handling systems are detected within a GPS threshold distance at block 618 or simply a user has been detected at block 616 by at least one information handling system and block 618 is skipped, the method proceeds to block 620 where the information handling systems may detect the user speaking a clustering trigger phrase aloud. For example, upon detection, via microphone 172 or 174, of the user speaking a clustering trigger phrase aloud, such as “form a cluster” or receives another clustering trigger at one information handling system, then the hardware processor 102 may execute machine readable code instructions 114 of the ad-hoc secured supercomputer cluster orchestration system 190 to sense the user’s position using beam-forming with microphone 172 or 174 and speaker 171 or 173, using ultra-wideband (UWB) radio frequency transmissions transceived via wireless interface adapters 120 or 181a, using wireless signal strength indicators for WLAN or Bluetooth ® sensing communications via wireless interface adapters 120 or 181a, or using a camera system in various embodiments of true presence sensing systems. If none of the information handling systems detect the user speaking the clustering trigger phrase aloud or another cluster formation command is not received, there may be no current need to form a supercomputing cluster at block 620 and the method may end. If at least one of the information handling systems detects the user speaking the clustering trigger phrase aloud, the method may proceed to block 622 to confirm that each of the information handling systems is in line-of-sight of the detected user in their current positional configurations using these true presence sensing systems.

Each information handling system in an embodiment at block 622 may sense the user’s location to sense the user’s position using beam-forming with microphones and speakers, using ultra-wideband (UWB) radio frequency transmissions transceived via wireless interface adapters, using wireless signal strength indicators for WLAN or Bluetooth ® sensing communications via wireless interface adapters, or using a camera system in various embodiments of true presence sensing systems. The hardware processor may execute machine readable code instructions of the ad-hoc secured supercomputer cluster orchestration system may also determine physical proximity of the information handling system to the user by receiving a distance and bearing of the user with respect to the information handling system via the wireless interface adapter, as measured using beam-forming with a microphone and speaker, ultra-wideband (UWB) radio frequency transmissions transceived via wireless interface adapters, wireless signal strength indicators for WLAN or Bluetooth ® communications emitted and measured via wireless interface adapters, camera systems, or proximity sensors such as IR time of flight sensors, ultrasonic sensors or others.

At block 624, in an embodiment in which true presence between the information handling systems has been confirmed, each of the information handling systems confirmed to be in true presence of one another or within line of sight of a user may share their IP addresses and global positioning satellite (GPS) locations with one another via the shared wireless communication network to identify one another. In such a way, a plurality of information handling systems may be used to determine that the plurality of information handling systems are in true presence of one another or are in line-of-sight of an individual user in their current positional configuration indicating a safer environment to automatically form an ad-hoc secured supercomputer cluster. The method for determining that a plurality of information handling systems are in true presence of one another or are in line-of-sight of an individual user with one or more true presence sensing systems may then end.

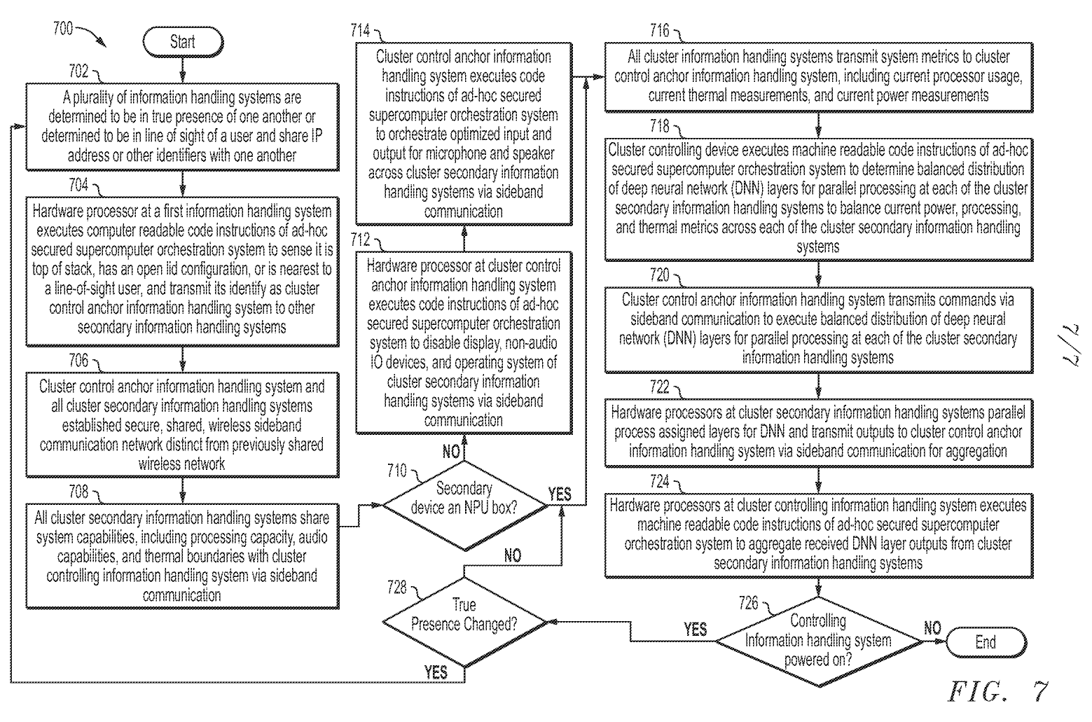

FIG. 7 is a flow diagram illustrating a method of forming an ad-hoc secure supercomputing cluster to perform parallel processing of deep neural network (DNN) layers across a plurality of information handling systems determined to be in true presence of one another or are determined to be in line-of-sight of a user via a true presence sensing system according to an embodiment of the present disclosure. As described herein, the ad-hoc secured supercomputer orchestration system in an embodiment may automatically form an ad-hoc secured supercomputer cluster of information handling systems that may include neural processing unit (NPU) artificial intelligence (AI) edge computing boxes or currently unused computers that in true presence of one another or are determined to be in line-of-sight of an individual user as determined from one or more true presence sensing systems to enhance security and to increase the available capacity for parallel processing deep neural network (DNN) layers across a larger plurality of information handling systems and hardware processors.

At block 702, a plurality of information handling systems in an embodiment may be determined to be in true presence of one another and share internet protocol (IP) addresses or other identifiers with one another. This may have been established with one or more true presence sensing systems herein and as described with respect to FIG. 6 above. Once true presence between the information handling systems or line-of-sight with an individual user has been confirmed using one or more of the above methodologies, each of the information handling systems may form an ad-hoc secure supercomputing cluster to perform parallel processing of DNN layers.

In an embodiment at block 704, a hardware processor at one of the information handling systems determined to be in true presence of the other information handling systems in true presence of one another or are determined to be in line-of-sight of a user may execute computer readable code instructions of an ad-hoc secured supercomputer orchestration system to sense or assign one information handling system as the controlling anchor information handling system for an automatic formation of an ad-hoc secured supercomputer cluster. In a first embodiment, a first information handling system may determine that it is located above the other information handling systems in a stacked configuration via a capacitive sensor. In a second embodiment, a first information handling system may determine that it is in proximity with a stack of NPU AI edge computing boxes and has an open lid. In a third embodiment, a first information handling system may determine that it is or is nearest to an individual user among a plurality of information handling systems within line-of-sight of that individual user in a room. These determinations may correspond to the various embodiments described in the present disclosure. This first information handling system then transmits its identity as the cluster controlling anchor information handling system to the other secondary information handling systems that have been sensed by the true presence sensing system.

At block 706, wireless interface adapters at the cluster controlling anchor information handling system and all other secondary information handling systems in true presence of the cluster controlling anchor information handling system may establish secure wireless sideband communication wireless links with the cluster controlling anchor information handling system that are distinct from the previously shared wireless network. For example, the wireless interface adapter 120 at the cluster controlling anchor information handling system 100 may work in tandem with all other information handling systems 130 and 140 in true presence of the cluster controlling anchor information handling system 100 to establish secure wireless sideband communication wireless links with the cluster controlling anchor information handling system 100 that are distinct from the previously shared wireless network 124. This may ensure that the communications and commands transmitted from the cluster controlling anchor information handling system to the remaining secondary information handling systems are secure and cannot be hacked by an individual outside of the room containing all of the information handling systems.

All secondary information handling systems in true presence of the cluster controlling anchor information handling system in an embodiment at block 708 may share system capabilities, including processing capacity, audio capabilities, and thermal boundaries with the cluster controlling anchor information handling system via the secure wireless sideband communication wireless links. All of the cluster controller anchor information handling system and secondary information handling systems 100, 130 and 140 may share system capabilities, including processing capacity, audio capabilities, and thermal boundaries with the cluster controlling anchor information handling system 100 via the secure wireless sideband communication wireless links.

At block 710, it may be determined whether any of the secondary information handling systems in true presence of the cluster controlling anchor information handling system are neural processing unit (NPU) artificial intelligence (AI) edge computing boxes that lack separate operating systems and input/output devices. If at least one of the secondary information handling systems in true presence of the cluster controlling anchor information handling system is not an NPU AI edge computing box, it may include a separate operating systems and input/output devices, and the method may proceed to block 712 to disable these components and dedicate processing power of the processing core on parallel processing commands issued solely by the cluster controlling anchor information handling system. For the secondary information handling systems in true presence of the cluster controlling anchor information handling system that are NPU AI edge computing boxes that lack separate operating systems and input/output devices, the method may proceed to block 716 for gathering of system power, thermal, and processing metrics for each of the information handling systems in true presence of the cluster controlling anchor information handling system to the cluster controlling anchor information handling system.

In an embodiment at block 712 in which at least one of the secondary information handling systems in true presence of the cluster controlling anchor information handling system is not an NPU AI edge computing box, the hardware processor at the cluster controlling anchor information handling system may execute code instructions of the ad-hoc secured supercomputer orchestration system to disable a display, non-audio IO devices, and operating system of the secondary information handling systems in true presence of the cluster controlling anchor information handling system that is not an NPU AI edge computing box, via the secure sideband communication wireless links. For example, the hardware processor 102 may execute machine readable code instructions 114 of the ad-hoc secured supercomputer cluster orchestrations system 190 to disable a display 177, non-audio IO devices 178, and operating system 179 of the secondary information handling system 130.

At block 714, the hardware processor at the cluster controlling anchor information handling system in an embodiment may execute code instructions of the ad-hoc secured supercomputer orchestration system to orchestrate input for a microphone and output for a speaker at the secondary information handling system(s) in true presence of the cluster controlling anchor information handling system that is not an NPU AI edge computing box to minimize echo or interference and coordinate acoustics across the entire cluster via the secure sideband communication wireless links. For example, the hardware processor 102 may execute machine readable code instructions 114 of the ad-hoc secured supercomputer cluster orchestrations system 190 to orchestrate input for a microphone 174 and output for a speaker 173 at the information handling system 130 to minimize echo or interference and coordinate acoustics across the entire cluster.

All secondary information handling systems in true presence of the cluster controlling anchor information handling system in an embodiment at block 716 may transmit system metrics to the cluster controlling anchor information handling system, including current processor usage, current thermal measurements, and current power measurements. For example, All information handling systems 130 and 140 in true presence of the cluster controlling anchor information handling system 100 may transmit system metrics to the cluster controlling anchor information handling system 100, including current processor usage, current thermal measurements (e.g., from thermal sensor 162b), and current power measurements.

At block 718 in an embodiment, the hardware processor at the cluster controlling anchor information handling system may execute machine readable code instructions of the ad-hoc secured supercomputer orchestration system to determine a balanced distribution of deep neural network (DNN) layers for parallel processing at each of the secondary information handling systems in true presence of the cluster controlling anchor information handling system to balance current power, processing, and thermal metrics across each of the secondary information handling systems in true presence of the cluster controlling anchor information handling system. For example, the hardware processor 102 may execute machine readable code instructions 114 of the ad-hoc secured supercomputer orchestration system 190 to determine, based on these received metrics, a balanced distribution of DNN layers for parallel processing at each of the information handling systems 100, 130 and 140 to balance current power, processing, and thermal metrics across each of the information handling systems 100, 130 and 140.

The wireless interface adapter at the cluster controlling anchor information handling system in an embodiment at block 720 may transmit commands via the secure sideband communication wireless links to execute the balanced distribution of DNN layers for parallel processing at each of the secondary information handling systems in true presence of the cluster controlling anchor information handling system. For example, the wireless interface adapter 120 may transmit commands via the secure sideband communication wireless links to execute the balanced distribution of DNN layers for parallel processing at each of the secondary information handling systems 130 and 140 as well as at the cluster controlling anchor information handling system 100 in embodiments herein.

At block 722, hardware processors at each of the secondary information handling systems in true presence of the cluster controlling anchor information handling system in an embodiment may parallel process the assigned layers for the DNN and transmit outputs therefor to the cluster controlling anchor information handling system via the secure sideband communication wireless links for aggregation. For example, various hardware processors of the secondary information handling systems, including central processing units (CPUs) or graphical processing units (GPUs) may be used to process the assigned layers along with an processors at the cluster controlling anchor information handling system in embodiments herein. As another example, NPUs at each of the NPU AI edge computing boxes within the supercomputer cluster may process the assigned layers.

In an embodiment at block 724, the hardware processor at the cluster controlling anchor information handling system may execute machine readable code instructions of the ad-hoc secured supercomputer orchestration system to aggregate the received DNN layer outputs from the secondary information handling systems in true presence of the cluster controlling anchor information handling system with those of the cluster controlling anchor information handling system. Following such a processing, the hardware processor 102 may execute machine readable code instructions 114 of the ad-hoc secured supercomputer orchestration system 190 to aggregate the received DNN layer outputs from the secondary information handling systems 130 and 140 and the cluster controlling anchor information handling system 100. In such a way, an ad-hoc secured supercomputer cluster of information handling systems 100, 130 and 140 may be formed that may include NPU AI edge computing box 140 or currently unused computers, such as 130 that are viewable in line-of-sight of an individual user to enhance security and to increase the available capacity for parallel processing DNN layers across a larger plurality of information handling systems 100, 130 and 140 and hardware processors.

At block 726, it may be determined whether the cluster controlling anchor information handling system has powered down. If the cluster controlling anchor information handling system has powered down, the need for forming a supercomputing cluster to perform parallel processing of DNN layers across a plurality of information handling systems may no longer exist, and the method may then end. If the cluster controlling anchor information handling system has not powered down, the method may proceed to block 728 to periodically confirm that each of the information handling systems within the ad-hoc secured supercomputer cluster are still in true presence of one another.

The cluster controlling anchor information handling system may work in tandem in an embodiment at block 728 with the other secondary information handling systems previously determined at block 702 to be in true presence of the cluster controlling anchor information handling system to confirm that each of these secondary information handling systems are still in true presence of one another. For example, the cluster controlling anchor information handling system 100 may work in tandem with the secondary information handling system 130 and NPU AI Edge computing box 140 previously determined to be in true presence of the cluster controlling anchor information handling system 100 to reconfirm that each of these information handling systems 130 and 140 are still in true presence of one another. For example, the wireless interface adapter 120 may receive from a position-altered secondary information handling system 130 or a position-altered secondary NPU AI edge computing box 140, an updated capacitive sensor measurement indicating lack of physical proximity of the position-altered secondary information handling system 130 or a position-altered secondary NPU AI edge computing box 140 from the information handling system 100 within the device stacking threshold distance. In such a case, the wireless interface adapter 120 may terminate the secured sideband communication wireless link with that position-altered secondary information handling system 130 or a position-altered secondary NPU AI edge computing box 140.

In another example embodiment described with reference to FIG. 2, the cluster controlling anchor information handling system 200 may work in tandem with the secondary NPU AI Edge computing boxes 241 and 242 previously determined to be in true presence of the cluster controlling anchor information handling system 200 to reconfirm that each of these secondary NPU AI Edge computing boxes 241 and 242 are still in true presence of one another and the cluster controlling anchor information handling system 200. For example, the wireless interface adapter 220 may receive from secondary NPU AI Edge computing box 241 an updated capacitive sensor measurement from capacitive sensor 245a indicating sensing of a second encoded electrical field from the secondary NPU AI edge computing box 242 that does not match the encoded electrical field generated by capacitive chassis 246a or indication of no sensing signal at all from the secondary NPU AI edge computing box 242. In such cases, the wireless interface adapter 220 may terminate the secured sideband communication wireless link with the secondary NPU AI edge computing box 242. In such a way, it may be possible to establish new secure sideband communication wireless links among a new group of secondary information handling systems that excludes the secondary NPU AI edge computing box 242 determined to no longer be in true presence of the cluster controlling anchor information handling system 200 and secondary NPU AI edge computing box 241 forming the previous cluster.

If it is determined that each of these secondary information handling systems are still in true presence of one another, the method may proceed back to block 716 to update measurements for processing capacity, remaining power, and current temperatures at each of the information handling systems. By repeating the loop between blocks 728 and 716 in such a way, it may be possible for the cluster controlling anchor information handling system to rebalance the DNN loads at each of the secondary information handling systems to balance power consumption, processing resource consumption, and thermal outputs across the plurality of secondary information handling systems forming the ad-hoc secured supercomputer cluster. If it is determined that any of the secondary information handling systems are no longer in true presence of one another, the method may proceed back to block 702 to identify a new group of secondary information handling systems that are confirmed to be in true presence of one another using the method described above with respect to FIG. 6. By repeating the loop between blocks 728 and 702 in such a way, it may be possible to establish new secure sideband communication wireless links among the new group of secondary information handling systems that excludes the secondary information handling system determined to no longer be in true presence of the cluster controlling anchor information handling system and the remainder of the secondary information handling systems forming the previous cluster. The method for forming an ad-hoc secure supercomputing cluster to perform parallel processing of DNN layers across a plurality of information handling systems determined to be in true presence of one another may then end.

The blocks of the flow diagram of FIGS. 6 and 7 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A first information handling system executing machine readable code instructions of an ad-hoc secured supercomputer orchestration system comprising:
a wireless interface adapter to receive from each of a plurality of secondary information handling systems, capacitive sensor measurements indicating physical proximity of the plurality of secondary information handling systems within a device stacking threshold distance of one another as a true presence sensor system;
a lid sensor to sense that a lid chassis for the first information handling system is open or situated at a highest vertical location with respect to the plurality of secondary information handling systems;
a hardware processor to execute machine readable code instructions of the ad-hoc secured supercomputer orchestration system to assign the first information handling system as a cluster controlling anchor information handling system and transmit instruction to the secondary information handling systems to dedicate core processing resources to an ad-hoc secured supercomputer orchestrated at the first information handling system;
the wireless interface adapter to distribute and transmit, via a plurality of secured sideband communication wireless links, deep neural network (DNN) layers for parallel processing across the plurality of secondary information handling systems to balance battery capacity, processing capacity, and thermal output across the secondary information handling systems; and
the wireless interface adapter to receive and aggregate, via the plurality of secured sideband communication wireless links, outputs of the parallel processing of the DNN layers from each of the plurality of secondary information handling systems.

2. The first information handling system of claim 1, wherein the capacitive sensor measurements indicate physical contact amongst the plurality of secondary information handling systems with stacking capacitive sensors at each of the plurality of secondary information handling systems and the first information handling system as the true presence sensor system.

3. The first information handling system of claim 1, wherein the capacitive sensor measurements of a top-of-stack first information handling system indicates no physical contact of any information located above and the hardware processor to execute the machine readable code instructions of the ad-hoc secured supercomputer orchestration system to assign the first information handling system as a cluster controlling anchor information handling system.

4. The first information handling system of claim 1 further comprising:
the wireless interface adapter to perform a secured wireless handshake with each of the plurality of secondary information handling systems as part of the true presence sensor system prior to establishing the secured sideband communication wireless links.

5. The information handling system of claim 1 further comprising:
the secondary information handling systems are neural processing unit (NPU) artificial intelligence (AI) edge computing boxes without display input/output (IO) capabilities and are stacked to facilitate thermal cooling of the NPU AI edge computing boxes with a chimney effect of thermal heat dissipation amongst the NPU AI edge computing boxes.

6. The information handling system of claim 1 further comprising:
an inertial measurement unit (IMU) to detect a physical contact with a secondary information handling system that occurred simultaneously to the capacitive sensor measurements indicating a physical contact amongst the plurality of secondary information handling systems with stacking capacitive sensors as the true presence sensor system prior to establishing the secured sideband communication wireless links.

7. The information handling system of claim 1 further comprising:
the wireless interface adapter to no longer detect the capacitive sensor measurement from one position-altered secondary information handling system of the plurality of secondary information handling systems indicating lack of physical proximity of the position-altered secondary information handling system to the first information handling system within the device stacking threshold distance; and
the wireless interface adapter to terminate the secured sideband communication wireless link with the position-altered secondary information handling system.

8. The information handling system of claim 1 further comprising:
the wireless interface adapter to receive from each of a plurality of secondary information handling systems capacitive sensor measurements including an encoded electrical field from a capacitive chassis of at least one secondary information handling system and exchanged amongst the plurality of secondary information handling systems indicating physical proximity of the plurality of secondary information handling systems within a device stacking threshold distance of one another as the true presence sensor system.

9. A method of automatically forming and orchestrating an ad-hoc secured supercomputer from a plurality of information handling systems comprising:
detecting, with a true presence sensor system at a first information handling system, a measurement indicating a physical proximity range of the first information handling system within a stacked plurality of secondary information handling systems that are neural processing unit (NPU) artificial intelligence (AI) edge computing boxes without display input/output (IO) capabilities;
the wireless interface adapter to receive capacitive sensor measurements from each of the plurality of secondary information handling systems indicating sensing of encoded electrical fields from a capacitive chassis of at least one of the plurality of secondary information handling systems;
determining that the first information handling system within the physical proximity range of the stacked plurality of secondary information handling systems is assigned as a cluster controlling anchor information handling system via a hardware processor executing machine readable code instructions of an ad-hoc secured supercomputer orchestration system;
distributing and transmitting, via a plurality of secured sideband communication wireless links with the wireless interface adapter, deep neural network (DNN) layers for parallel processing across the plurality of secondary information handling systems to balance battery capacity, processing capacity, and thermal output across the plurality of secondary information handling systems; and
receiving and aggregating, via the plurality of secured sideband communication wireless links with the wireless interface adapter, outputs of the parallel processing of the DNN layers from each of the plurality of secondary information handling systems.

10. The method of claim 9 further comprising:
receiving, via the wireless interface adapter, an updated capacitive sensor measurement from at least one of the plurality of secondary information handling systems indicating sensing of a non-identical encoded electrical field at a position-altered one of the secondary information handling systems; and
terminating the secure sideband communication wireless link with the position-altered one of the secondary information handling systems.

11. The method of claim 9 further comprising:
determining, via the wireless interface adapter, the physical proximity range of the first information handling system to the stacked plurality of secondary information handling systems using ultra-wide band (UWB) radio frequency transmissions as part of the true presence sensor system.

12. The method of claim 9 further comprising:
determining, via the wireless interface adapter, the physical proximity range of the first information handling system to the stacked plurality of secondary information handling systems using capacitive sensing of the first information handling system on top of the stacked plurality of secondary information handling systems as part of the true presence sensor system.

13. The method of claim 9, wherein at a stacked configuration of the stacked secondary information handling systems facilitates thermal cooling of the NPU AI edge computing boxes with a chimney effect of thermal heat dissipation amongst the NPU AI edge computing boxes.

14. The method of claim 9, wherein the wireless interface adapter determines the physical proximity range of the first information handling system to the plurality of stacked secondary information handling systems using ultra-wideband (UWB) radio frequency transmissions as part of the true presence sensing system.

15. A first information handling system executing machine readable code instructions of an ad-hoc secured supercomputer orchestration system comprising:
a wireless interface adapter to determine at the first information handling systems and to receive from each of a plurality of secondary information handling systems measured locations of each of the plurality of secondary information handling systems having a plurality of distances in a line-of-sight with a detected individual user as a true presence sensor system;
a hardware processor executing machine readable code instructions of the ad-hoc secured supercomputer orchestration system to determine a location of the individual user with respect to the first information handling system and within line-of-sight of the individual user at a distance that is less than each of the plurality of distances received from the plurality of secondary information handling systems;
a hardware processor to execute machine readable code instructions of the ad-hoc secured supercomputer orchestration system to assign the first information handling system as a cluster controlling anchor information handling system;
the wireless interface adapter to distribute and transmit, via a plurality of secured sideband communication wireless links, deep neural network (DNN) layers for parallel processing across the plurality of secondary information handling systems to balance battery capacity, processing capacity, and thermal output across the cluster subordinate devices; and
the wireless interface adapter to receive and aggregate, via the plurality of secured sideband communication wireless links, outputs of the parallel processing of the DNN layers from each of the plurality of secondary information handling systems.

16. The first information handling system of claim 15 further comprising:
the hardware processor executing machine readable code instructions to detect presence of an individual user based on measurements from a microphone, camera, or infrared (IR) detector as part of the true presence sensor system prior to establishing the secured sideband communication wireless links.

17. The first information handling system of claim 15 further comprising:
a global positioning satellite (GPS) unit to measure a geographic location of the first information handling system within a threshold true presence distance of each of the secondary information handling systems as part of the true presence sensor system prior to establishing the secured sideband communication wireless links.

18. The first information handling system of claim 15 further comprising:
a microphone to detect the individual user stating a clustering trigger phrase to trigger determining distances with the true presence sensor system prior to establishing the secured sideband communication wireless links.

19. The first information handling system of claim 15 further comprising:
the hardware processor executing machine readable code instructions of the ad-hoc secured supercomputer orchestration system to disable digital displays, non-audio input/output devices, and operating systems of the secondary information handling systems and dedicate processing cores of the secondary information handling systems to an ad-hoc secured supercomputer orchestrated by the first information handling system.

20. The first information handling system of claim 15 further comprising:
the hardware processor executing machine readable code instructions of the ad-hoc secured supercomputer orchestration system to adjust settings for audio input/output devices at each of the secondary information handling systems to minimize echo or interference.
